(19) United States
(12) Patent Application Publication
(10) Pub. No.: US 2005/0143136 A1
(43) Pub. Date: Jun. 30, 2005

(54) Mms system and method with protocol conversion suitable for mobile/portable handset display

(76) Inventors: Tvsi Lev, Tel Aviv (IL); Ran Avnimelech, Ramat Gan (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/482,566

(22) PCT Filed:
(86) PCT No.: PCT/IB02/04148

Related U.S. Application Data
(60) Provisional application No. 60/299,745, filed on Jun. 22, 2001.

(51) Int. Cl. H04B 1/38

(52) U.S. Cl. 455/566

(57) ABSTRACT

An MMS communication system for displaying images on a display terminal of a mobile or portable communication device, the system comprising: an input adapted to receive pre-source information; a transmitter adapted to transmit the pre-source information; a server adapted to receive the transmitted pre-source information and further adapted to convert the pre-source information to source information suitable for display on the display terminal, and a source transmitter adapted to transmit the source information to the display terminal.

### RELATED APPLICATIONS

This Application claims priority from co-pending U.S. Provisional Application Ser. No. 60/299,745 filed Jun. 22, 2001, which is incorporated in its entirety by reference.

### FIELD

This disclosure teaches techniques related to an MMS (Multimedia Messaging System), including images, graphics, numerics, and text, suitable for display on the display of a mobile or portable communication handset terminal.

### BACKGROUND

Glossary of Technical Terms

To understand the disclosure better, the following definitions for technical terms used in this disclosure is provided:

1. EMS: Extended Messaging System, a source protocol used for EMS handsets, designed to encode multimedia messages, Including images, graphics, numerics, animations, audio and formatted text.

2. MMS: A pre-source (multimedia+formatting information) protocol used to encode types of messages, including images, graphics, numerics, and text, and transcoded for the display phone speaker on various display terminals. Used in most Nokia handsets.

3. PM: Picture Messaging protocol, a graphic format (source protocol) used to display S/W Images in Nokia handsets supporting the NSM per source format.

4. Pre-source information: In this application, information, which may be a full multimedia message or some part thereof, which appears in a non-source format and is not coded in a source protocol. Pre-source information refers to “packaged” multimedia content in a “raw” format such as:

a. A set of TCP/IP packets composing a MIME multipart message (could be an email message or an MMS MM1 message), where some parts of the message are media objects which need to be converted/transcoded, and some other parts (e.g. SMIL attachment) are presentation layer Information relating to how the information has to be arranged and displayed Figa. 24 and 25 illustrate this concept,.

b. A block of SMS messages that together compose an EMS or a Nokia Smart Messaging (NSM) message and contain multiple media objects—pictures, ringtones, etc. These SMS messages are further encapsulated into the SMSC protocol which can be SMPP, UCP, CIMD etc.

5. Smart Messaging: A source protocol being developed by Nokia for Nodia handsets. This refers to everything defined in the NSM pre-source protocol and adds functionality for calendar events (vCalendar), electronic business cards (vCard) etc.

6. Source information: In this application, information, which may be a full multimedia message or some part thereof, which appears in a source format and which is coded in a source protocol. Typical source protocols are WBMP, EMS, and PM, but new protocols are being developed on an ongoing basis. Source protocols enable the display of messages on terminals with limit memory, processing, and display capabilities, such as those of mobile and portable radio communication handsets (i.e. cellular telephones, land mobile radios, Instant Messaging terminals, radio enabled PDAS, and the like). On the other hand, source information constitutes media objects in some media format, e.g. a JPEG picture, an MP3 audio file, an AVI video etc.

7. Transcoding: To perform protocol conversion, either from one source protocol to another, or from a pre-source protocol into a source protocol.

8. WAP, “Wireless Application Protocol”, one protocol used for what have been called 2.5G cellular systems. In the cellular world, 1G was the original set of analog cellular systems 1G has been mainly displaced by 2G systems, which are low-speed digital systems, which a typical raw data rate of 9.5 kbps. Operators are currently deploying what are known as 2.5G systems, which are higher speed digital systems, expected to operate up 384 kbps 2.5G systems are expected to be replaced by 3G systems, which are higher speed digital systems promising speeds up to 2 Mbps, WAP is one of the chief manifestations of 2.5G systems WAP Is a pre-source protocol.

9. WBMP: The display protocol for handsets in the WAP system.

Introduction

The process of transcoding is not a new idea. Indeed, in forms the basis of communication systems. Even the conversion from analog to digital, or vice verse, is a form of transcoding. With the proliferation of higher speed digital cellular systems, the challenge and the problem of transcoding have become much greater. There is, as yet, no standard display protocol for higher speed communication terminals. Therefore, transcoding from one display protocol to another is required to insure that the receiving terminal will be able to display the transmitted. There is, however, no method or system to do this in such a way that the integrity and quality of the transmitted message will be maintained in the display terminal. Further, there is no method or system for transcoding non-source information into a source protocol suitable for display on a communication terminal, while maintaining the integrity and quality of the information which originally appeared in the non-source format. There are transcoding systems and methods, to be sure, but they are primitive, and lose much of the quality of the source or pre-source information, even to the point where in some cases the displayed information in the display terminal is not recognizable. What is required is algorithms, a method, and a system, that will allow identification of the specific display characteristics of the target display terminal, and will also allow the source or pre-source information to be displayed on the target display terminal with the maximum amount of integrity and quality in comparison to the pre-coded information.

### SUMMARY

The disclosed teachings provide for:

1. Conversion of source information coded in a source format into a protocol suitable for transmission to and display on the terminal A variety of new processing techniques are disclosed, Source information is typically coded in protocols such as WBMP (the protocol for Wireless Application Protocol, or “WAP”, systems), EMS, and PM. This information must be transcoded for display on different terminals, also using source protocols, but where the protocols and variations of the protocols are typically different between the input source and the display terminal.

2. Conversion of pre-source information, that is, information which is coded but not in a source protocol, into a source protocol. For example, an ordinary digital picture will be transcoded into the source protocol WBMP. It will be appreciated that information in source protocol will then be transcoded again into the target source protocol, as explained in introductory point 1 immediately above.

An MMS communication system for displaying images on a display terminal of a mobile or portable communication device, the system comprising: an input adapted to receive pre-source information; a transmitter adapted to transmit the pre-source information; a server adapted to receive the transmitted pre-source information and further adapted to convert the pre-source information to source information suitable for display on the display terminal; and a source transmitter adapted to transmit the source information to the display terminal

### BRIEF DESCRIPTION OF THE DRAWINGS

The above advantages of the disclosed teachings will become more apparent by describing in detail preferred embodiments thereof with reference to the attached drawings in which:

FIGS. 1-37 show various features of the disclosed teachings as described in the rest of this document.

### DETAILED DESCRIPTION

Overall Architecture

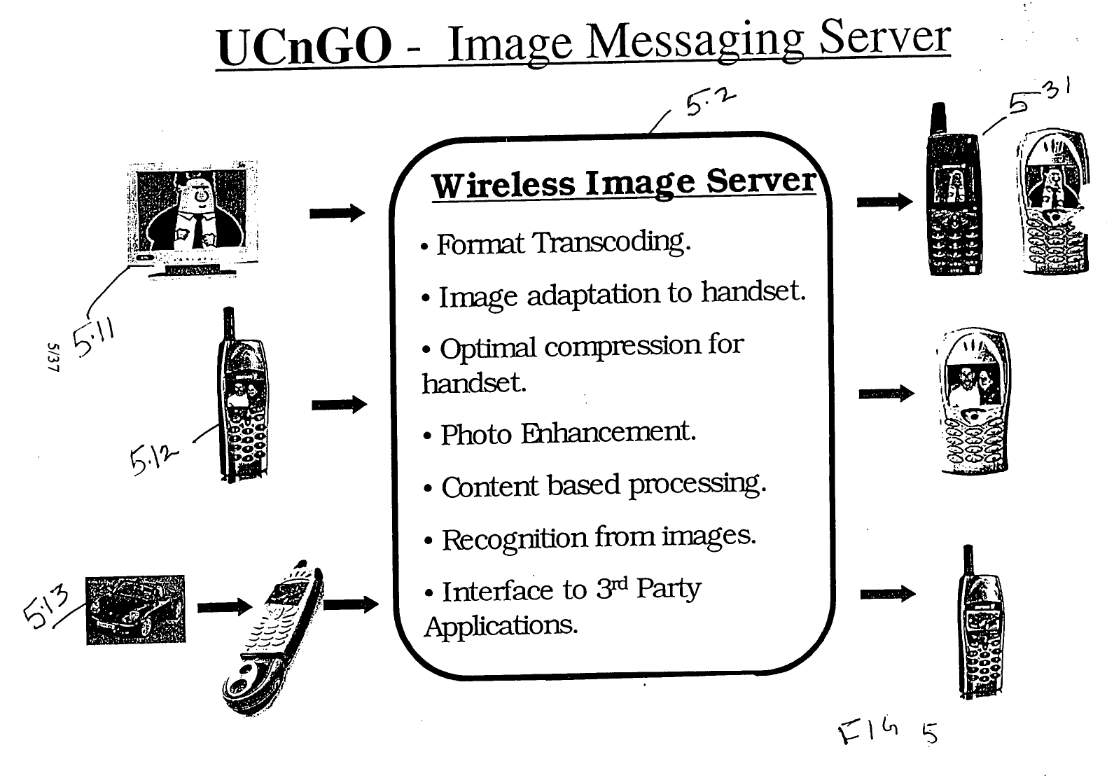

An implementation of the disclosed teachings is shown in FIG. 5. The structure includes the input devices 5.11-5.13 on the left, the server 52 represented by the block in the middle, and the display devices 5.31-5.34 shown on the right information may be in source format, as is the case for the cellular telephone 5.12 (picture of two people) and the digital camera attached to a cellular telephone 5.13 (picture of the automobile) Or information may be in a pre-source format, such as the cartoon of the man 5.11. At the server, the source information or pre-source information is processed by a variety of components, adapted to implement a variety of algorithms or techniques, which form an integral part of the disclosed teachings.

Some of the components mentioned above perform at least the following tasks:
1. Format transcoding (from the pre-source information into source information, or from source information into other source information suitable for display on the display terminal);
2. Image adaptation, to adapt the image to the particular display screen on the display terminal, (This is discussed in further detail in section IVG);
3. Optimal compression for handset. The display terminal cannot display all of the bits of the original information. The information must be compressed, both for transmission and for display.
4. Photo enhancement: Specific sections of a photograph may be cutout and enhanced. (This is discussed in further detail in section IVG);
5. Content based processing, by which different aspects of a multimedia message are identified and processed differently. (This is discussed in further detail in section IVG);
6. Recognition from images: This is allied to the photo enhancement algorithm. Different portions of an image are recognized and “cutout” for enhancement. (This is discussed in further detail in section IVG);
7. Interfaces to 3rd Party Applications: Third party applications may be processed separately and sent to the display terminals, or may be added to the original information. In addition, if there are software packages with additional algorithms for additional processing of the source information, these may abe accessed and applied to the original information for eventual display on the display terminals. An example of an interface to a third party application is an XML-based interface over TCP/IP. Another example of such an interface would be and API in C++ or Java. By third party application we are referring to both external SW modules, and to VAS—value added services—e.g. a news service, a gaming platform for cellular phones (for example www.wirelessgames.com, www.cash-u.com), a photo album service. These applications wish to send MMS content and also in certain cases to perform special processing on such content prior to sending it. For a review of the special functionality please refer to section IV. H.

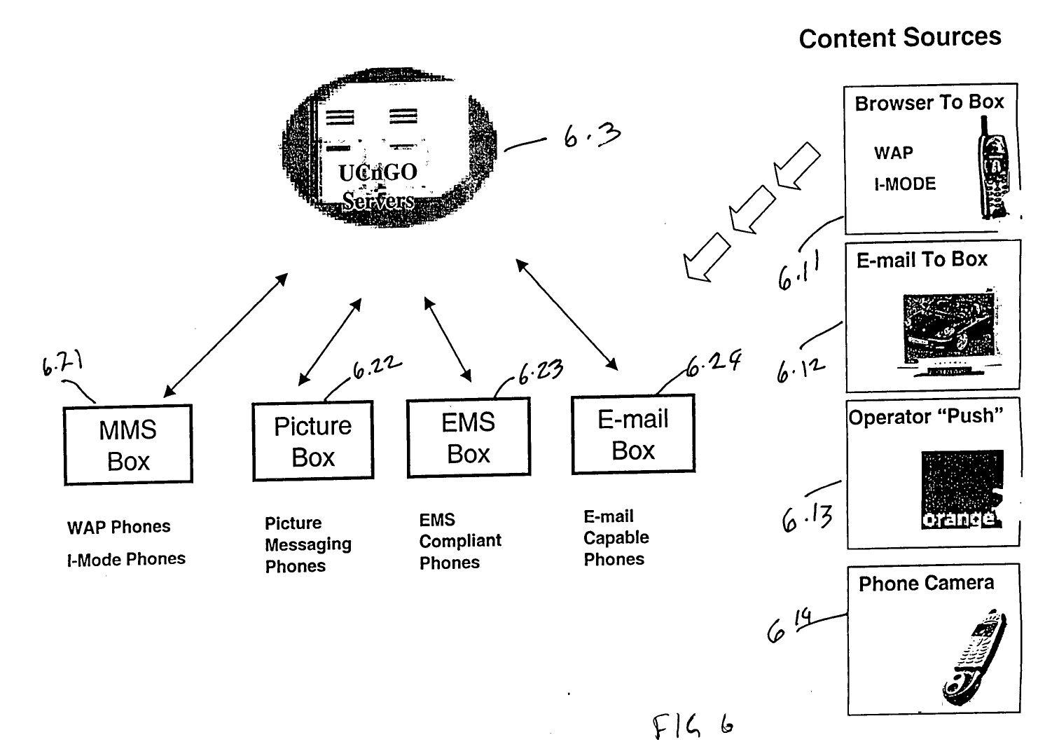

Another implementation of the disclosed teachings is shown in FIG. 6. Examples of input sources, called “Content Sources”, 6.11-6.14, appear in the column at the right. However, the input sources are much broader than these pictures. At the bottom of the figure are various information devices 6.21-6.24 which can serve as both sources of information to the server 6.3, and also receivers of information processed by the server. These information sources can be WAP or i-Mode Phones, called “MMS Box” in the slide. (i-Mode phones are those that operate on i-Mode 2.5G cellular systems currently functioning in Japan. i-Mode phones will also operate on 3G systems expected to be introduced in Japan in late 2001 and in 2002.) Picture messaging phones, operating with the PM protocol, are portrayed in the “Picture Box”. Similarly, EMS phones, operating with the EMS protocol, are portrayed in the “EMS Box”. Finally, Email enabled phones are portrayed in the “E-mail Box”. In this implementation, information may be coded out of or coded into, any of the protocols show, including WAP phones (WBMP protocol), I-Mode Phones (the Japanese version of WAP), Picture Messeging Phones (PM protocol), EMS Compliant Phones (EMS protocol), and E-mail Capable Phones (POP3, SMTP, and IMAP4 protocols).

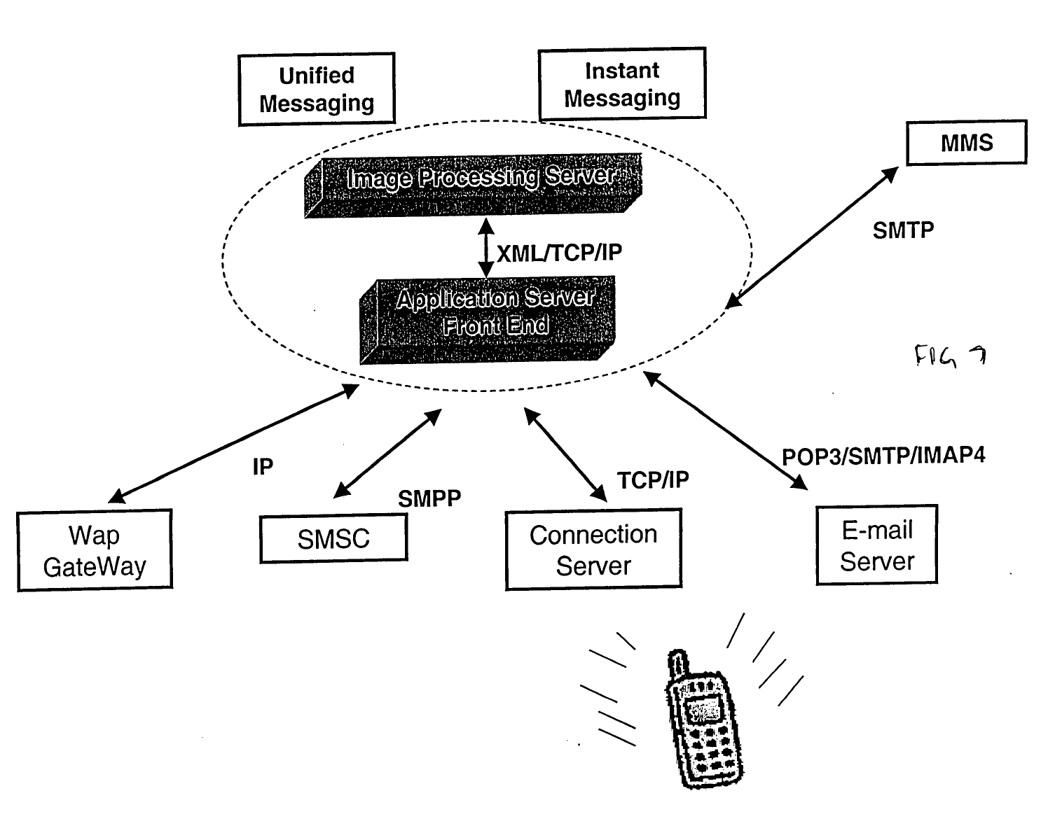

The server will receive, transcode, and optimize for display on a specific communication terminal, at least any of the following protocols: IP, SMPP, TCP/PT POP3/SMTP/IMAP4/XML This is illustrated in FIG. 7.

Using the transcoding several tasks are accomplished, for example:

1. The conversion from and into any of the various formats WBMP, PM, and EMS.

2. The conversion of formats on the fly when the user logs on to his or her MMS box (so that even if the user were to switch terminal devices, he or she would get the correct content, properly formatted).

3. The conversion taking into account the exact parameters (such as, for example, screen size, pixel dimensions, etc.) of the particular terminal and terminal display.

4. Transcoding of source information into other source information suitable for display on a target terminal, maintaining integrity and quality of the original message, examples would be:

a. A JPEG image is converted to a GIF image so that a phone with a WAP browser than can display GIF Images will be able to view it.

b. A Nokia ringtone is converted to an EMS iMelody ringtone so that a non-Nokia phone can play it.

c. A video in MPEG1 format is converted to MPEG4 Simple Visual profile so that an MMS compliant phone can display it, or to an animated GIF sequence so that a non-MMS compliant (legacy) phone can view it.

d. Formatted text in the EMS format can be converted to an image or to HTML+text to preserve the formatting (underline, bold, letter size etc.).

It should be noted that both the EMS and NSM formats include not only images but also ringtones, animations and formatted text. This fact is well documented in the EMS/NMS standards documents for the last few years.

5. Transcoding of non-source information into other source information, for later transcoding into source information for display on a specific target terminal, where all transcoding maintains the integrity and quality of the original message.

6. Recognizing the specific display characteristics of a specific target display terminal, to enable the display of high quality messages, whatever the characteristics of the terminal.

An Example Implementation: Overview

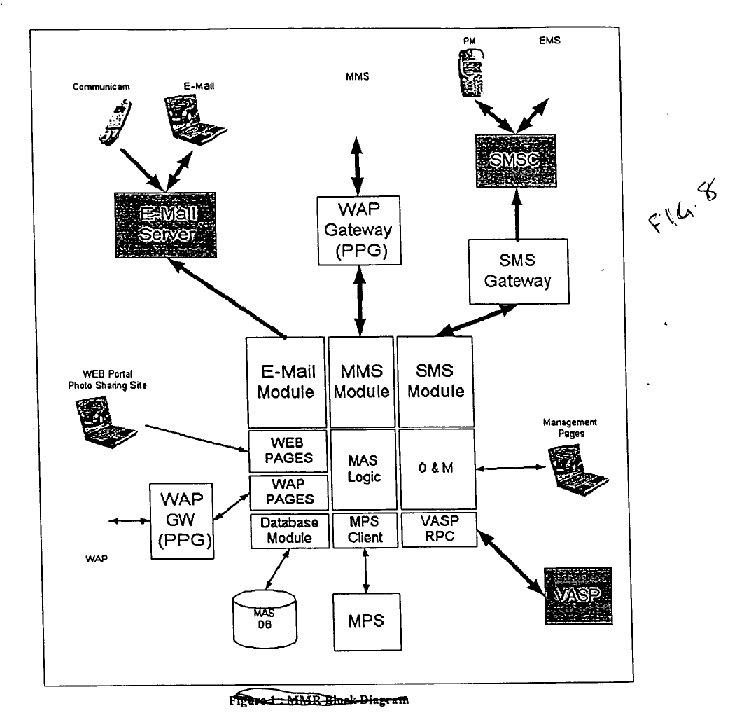

FIG. 8 shows another example implementation of the overall system. This implementation is called MMR. The MMR system allows users to send and receive messages containing text and images at least in the following formats/protocols: WAP; PM; EMS; MMS; E-MAIL; WEB; SMS.

While the term message and information has been used in discussing the implementations in detail, it should be clear to a skilled artisan as to which message/information constitutes pre-source information and which constitutes source information according to the definitions for the same provided in the background.

User WAP Pages

The MMR provides a WAP based messaging application, allowing users to login to their personal messaging page. From this page users can view and send messages in variety of formats. The MMR sends the WAP recipient an SMS notification with a link to the newly received message. Alternatively, the MMR can send a WAP push message with the same link. MMS recipients receive a notification to the new MMS. PM and EMS recipients receive the message directly. Email recipients receive an e-mail with an image attachment to their regular e-mail address.

It should be noted that WAP pages can contain multimedia for immediate integrated display (e.g. a WBMP image), but can also contain downloadable multimedia such as higher resolution images, ringtones, animations etc., as part of e.g. the M-Services standard for downloadable media.

User Web Pages

The MMR provides a WEB based portal for three major function.

1. Users can register themselves to the system, by submitting personal information as well as information about the model of their mobile device.

2. A photo album application is provided for personal storage and sharing of images and audio files. Users can login to their personal accounts, view and send messages to mobile device, in the same manner as described above.

3. Users can also login to an HTML based messaging page which allows them to view all their received messages. Regardless of the format in which these messages were originally sent, these messages will be transcoded to be viewed on a normal web browser. This may allow users to view messages in a much higher quality than that seen on their mobile devices.

MMS Module

The MMR can send and receive MMS messages to and from mobile devices. Incoming MMS messages are parsed and transcoded for optimal display on the recipient's device. Recipients of outgoing MMS messages receive a notification, allowing them to download the message from the MMS proxy. Other recipients receive the MMS message after it has been transcoded to WAP, PM, EMS, SMS or E-Mail.

Email Module

The MMR allows users to send E-mail messages with image attachments to mobile devices. It also allows mobile users to send E-Mails with image attachments to regular e-mail addresses. Incoming E-mails are parsed. The e-mail subject is sent as the message text, while each of the image attachments in the original e-mail are transcoded for the mobile device. Depending on the amount of attachments, the recipient may receive several messages, and a format most suitable to his mobile device. Outgoing e-mail messages use SMTP to send the message text along with an image attachment to the selected recipient (any e-mail address).

It should be noted that the e-mail interface is also utilized for sending images from an Ericsson Communicam to other mobile devices. Communicam images are posted from the camera to a dedicated server, which converts these images to an e-mail with image attachments. Proper configuration of the e-mail recipient address allows the user to send these images to other mobile devices. Communicam is a specific commercial line of cameras that can be attached to phones. It is referred here to a general camera attached to a phone.

SMS Module

The MMR allows users to send messages in several SMS based formats. Picture Message for Nokia phones, and EMS messages for Ericsson phones are supported.

Incoming messages are transcoded into PM and EMS, dividing the original message into up to 6 SMS messages. The recipient's phone receives these SMS messages, and concatenates them. When all SMS messages have arrived, an application on the mobile device displays the message content.

It should be noted that MMR can also receive PM and EMS messages originating from mobile devices, and transfer these messages in different formats to other devices. This feature requires a special agreement between the SMS service provider and the MMR operator, in order to forward all concatenated SMS messages through the MMR.

The conversion a full message (pre source with source objects) is a conversion where certain constraints and relations between the media objects requires more processing and application of “business rules”: for example, if an EMS message which is 6 SMS long is sent to a Nokia phone (NSM messages are up to 3 SMS long) some or all of the following operations may take place:

a. The images get resized to reduce their size in bytes.

b. The Audio files get truncated to reduce their size in bytes.

c. The text formatting may be removed to reduce total message size.

MMR Logic

The MMR-Logic controls the behavior of the MMR. Using the MMR database, and set of configurable rules, the MMR Logic selects the most suitable message format for each recipient. It then determines the correct data flow path for each of the possible message transactions. The MMR-Logic is also responsible for the on-the-fly gathering of information about users and their mobile devices. This is performed by e.g. registering the WEB/WAP user-agent of the phone when it sends requests, or by identifying the type of the message sent from a phone (e.g. an EMS message) which indicates that this phone can send/receive message in this format.

MMR Database

The MMR database stores information about the system users, such as name, phone number, phone model etc. Message contents, i.e. images, audio and text, are also stored in the database. The MMR database also contains information required by the O&M block.

O&M

The MMR O&M functions provide the MMR system administrator with an array of tools to monitor and control the behavior of the MMR. A Web based interface, provides the administrator access to web pages, arranged in groups according to the functional blocks in the MMR.

The O&M also provides the administrator with a messaging page, which allows him to send messages in all formats to mobile devices.

MPS Client

The MPS client translates the required transcoding action, as determined by the MMR-Logic block, into an XML request. This request is then posted to the MPS server rack The MPS client then parses the response, and extracts the transcoded image. Further details are found in section IV.I.

MPS (Media Processing Server)

The media-processing server handles the message transcoding from one format to the other. Other image processing functions such as face detection can also be called via the XML interface.

VASP RPC Module

The MMR provides an external interface to Value Added Service Providers (VASP), allowing remote invocation of MMR functions via an XML RPC interface.

Tthe XML RPC infrastructure can be easily expanded to include additional remote procedure calls. Details are found in sections IV H and the last section titled MPS control interface document.

Internal WAP GW

The MMR hosts an internal WAP gateway. This gateway is required to support functionality not yet supported on commercially deployed gateways. The internal WAP gateway allows the MMR to send/receive MMS messages, as well as use WAP push for message notifications. The inclusion of an internal WAP gateway is optional, not a must. An external MMS compliant WAP gateway supporting segmentation and re-assembly (SAR) and MMS tags/mime types can be used.

Internal SMS GW

The internal SMS GW is used due to special functionality required for receiving EMS and PM messages. The SMS gateway is an interface layer/mediator for receiving and sending the SMS messages from/to an SMS center (SMSC) via the prevailing protocols such as UCP, SMMP, CIMD etc.

Details of Selected Functional Blocks

User Web Pages—The MMR Web Site

The public MMR main web portal contains links to at least the followingr functions:
Link to the user's personal web based “Messaging Application”
Link to the “Photo Album”
Link to the “User Registration Page”

Web-Based Messaging Application

The web based messaging application provides similar functional capabilities to the wap based application. User's may enter their personal messaging page, by using the same user name and password as used on their mobile phones. Once inside, user's can view and send messages in a variety of formats.

From the web-based application, users can also send messages with original content.

Web-Based Photo Album

The MMR provides a web based photo album application, allowing the user to upload and manage their own folders containing images and audio files. These files can then be shared with friends, or sent to mobile devices in a variety of formats.

The MMR can automatically select the message format most suitable for the recipient, or may receive a request from the sender to send the message in a specific format.

Web-Based User Registration Page

The user registration page allows new users to register themselves to the service. It also allows registered user's to update their registration information. Registration information requires the user to submit some personal details, as is accustomed in web based email services. In addition to this information, the user can be asked to submit information regarding the model of his mobile device.

The E-Mail Module

The MMR allows users to send E-mail messages with image attachments to mobile devices. It also allows mobile users to send E-Mails with image attachments to regular e-mail addresses. Incoming E-mails are parsed. The e-mail subject is sent as the message text, while each of the image attachments in the original e-mail are transcoded for the mobile device. Depending on the amount of attachments, the recipient may receive several messages, and a format most suitable to his mobile device. Outgoing e-mail messages use SMTP to send the message text along with an image attachment to the selected recipient (any e-mail address).

Email Server Account Set-Up

The e-mail server needs to be configured to receive all mails addressed to a selected domain, e.g. pics.ucngo.com. All incoming e-mail messages in this format are accepted by the e-mail server. Furthermore, the server is configured to create an event for each incoming message. This event triggers the MMR to handle the new message an described in the sections below.

Email to Mobile Device

1. Receive messages sent to: user-phone-numberpics.ucngo.com e.g. 97254985026@pics.ucngo.com.

2. The e-mail is handled as follows:
i) The email subject is extracted, and used as the message text. (The message text is limited to 120 characters (configurable)).
ii) The phone is extracted from the email address and used as the recipient's number.
iii) The Image attachments are used as the message images. Each attached image generates a new mobile message, with the same message text. The maximum allowed message size is 150 Kbyte (configurable).

3. The message is stored in the message table of the MMR database.

4. The MMR-Logic selects the optimal message format for the recipient.

5. A message in the selected format is sent to the recipient.

Outgoing Error Messages

Incoming e-mail messages that can not be handled according to the logic above, will generate an error message. This error message will be sent to the e-mail originator, to notify him that his message could not be handled. For several expected cases, the exact error will be given, to explain why the message could not be handled:
i) Recipient number is not a valid number, or is unknown to the system.
ii) Message does not contain a valid image attachment.
iii) Message attachments are larger than the allowed quota.

Mobile Device to E-mail

Mobile devices may send e-mail messages via the WAP messaging portal.

During the process of sending a message, the WAP user is provided with a “send as” link, allowing him to select from a list of optional formats.

By selecting “send as e-mail” the user prompts the following chain of events:
i) A new e-mail message is composed.
   ii) The image original is taken from the message database, and sent as an e-mail attachment.
   iii) The message text, as edited by the user is sent as the e-mail body.
   iv) The e-mail subject is a generic message in the form of: “You have received a new mobile e-mail from <sender number>”
   v) The recipients e-mail address can be entered in one of two ways:
   1. If the e-mail recipient is a registered user, the sender may type in the recipient's phone number, and the MMR will lookup the recipient's e-mail address from the database.
   2. If the recipient is not registered, or if his e-mail address is not known, the sender will be directed to a wap page from which he can edit the required e-mail address.

SMS Based Messaging

The SMS-based module is in charge of generating at least the following message format: EMS, PM, WAP link notification (SMS or WAP-push), WAP-push MMS notification, Text SMS for devices that do not support images.

Furthermore, the SMS module includes an SMS link layer, capable of receiving EMS and PM messages from mobile devices. The link layer can then concatenate the fragmented SMS messages that make up an EMS or PM and extract the message image and text. These messages can then be transcoded into any of the supported formats.

The MAS core is a group of java servlets, that handle image transcoding management/message transfer/database functions/billing and O&M functions.

These servlets have external interfaces to an Email server, SMS center and WAP/WEB gateway allowing the MAS to interconnect between devices using these protocols. Refer to the: SMS/EMS/PM Module for a more detailed block diagram of the SMS/EMS/PM modules. Refer to the: MAS E-Mail Module for a more detailed block diagram of the POP3/SMTP modules.

The PM/EMS/SMS receive will be handled by a dedicated servlet, it will interface all incoming SMS's handled by the SMS GW. It will encode the incoming SMS's using the following top level logic:
1) Detect type of message single, concatenated
2) For Single Message:
a) Detect Type of message Text, PM, EMS
b) Extract image or Text from message
c) Post data to with text & phone number to sms handler servlet
3) For Concatenated Message Store in local db with message iD
4) When Last message received—(from analyzing XX,YY,NN: XX—msg id, YY—total number of msgs, NN—msg sequence in the UDH) and tracckin sequence of received messages, do:
a) Concatenate message data
b) Detect Type of message Text, PM, EMS
c) Extract image or Text from message
d) Post data to with text & phone number to sms handler servlet

MMR-MM1 System Logic

The MMR Logic module determines the data flow path and transcoding type used on messages that go through the system. Sub-section 4(a) defines the chain of events that take place, for each of the possible combinations of input and output formats. However, there are cases where the recipients phone capabilities are either not fully known, or the recipient's phone may be able to accept messages in more than one format.

Subsection 4(b) deals with selecting the correct message type for the recipient. This sub-section deals with scenarios where either the sender or recipient's information is either not known to the system, or it conflicts with previous information stored in the MMR about the user.

Transcoding Matrix

The MMR enables messages to be sent from one device to the other, automatically transcoding the message content from the source device format to the target device format.

The supported formats are: WAP/WEB/E-Mail/PM/EMS/MMS/SMS.

The following sub-sections describe some of the various transcoding actions taken for each combination of source and destination formats.

WAP to WAP

Image source data is already in the database.

Send notification to the recipient with a link to the new image.

Transcode the image when the recipient enters the message page according to the UA used.

WEB to WAP

Upload new image via HTTP to the database.

Send notification to the recipient with a link to the new image.

Transcode the image when the recipient enters the message page according to the UA used.

WEB to Preview

Upload new image via HTTP to the database. [135] Transcode the image to the expected recipient phone type.

Transcode the image from the format above to the PC monitor format.

Display resulting image wrapped in some html.

Delete the image original from the database.

E-Mail to WAP

Extract images and recipient numbers.

For each recipient send all the images.

Send notification to the recipient with a link to the new image.

Transcode the image when the recipient enters the message page according to the UA used.

WAP to E-Mail

Take image original from the database.

Transcode to GIF or JPEG to a size no larger than 25 Kbyte (Configurable).

Send to recipient's e-mail address.

WAP to PM/EMS/MMS

Take image original from the database.

Transcode to PM/EMS/MMS according to recipient phone type.

Send message.

WEB to PM/EMS/MMS

Upload image from web or photo-sharing site.

Transcode to PM/EMS/MMS according to recipient phone type.

Send message.

E-Mail to PM/EMS/MMS

Extract images and recipient numbers.

For each recipient send all the images.

Transcode the image to PM/EMS/MMS according to recipient's phone type.

Send message.

SWAP/WEB/E-Mail to SMS

This mode will be used when the recipient's phone cannot display images.

The message text will be sent as an SMS to the recipient.

EMS/PM to WAP*

Receive and store EMS/PM as fragmented SMS messages.

Link fragments to a complete EMS/PM

Send notification to the recipient with a link to the new image.

Transcode the image when the recipient enters the message page according to the UA used.

EMS/PM to EMS/PM*

Receive and store EMS/PM as fragmented SMS messages.

Link fragments to a complete EMS/PM

Create and send an EMS or PM according to the recipients known device capabilities.

EMS/PM to MMS*

Receive and store EMS/PM as fragmented SMS messages.

Link fragments to a complete EMS/PM

Transcode EMS/PM into MMS format.

Initiate an MMS transaction with the WAP Gateway.

All to SMS

Strip images froth the original content.

Send the first 160 characters of the text message as an SMS message.

MMS to All Formats

Receive the MMS message. Extract the content files and the SMIL.

Insert the all image and audio files into the database.

Enter the SMIL file into the database. Transcode the SMIL information into HTML/WML/EMS formatting information if the targets are WEB, WAP, EMS respectively. If the target is email or an MMS phone that does not support SMIL, the media objects (MIME objects) may be reordered based on the information in the SMIL description to ensure proper viewing order between the various media objects.

Send the message to the selected output format, as if it came from the WEB. *-Requires redirection of concatenated SMS messages by the SMSC through the MMR. The MMR then handles EMS/PM messages according to the above logic.

Sender and Recipient Logic

In order to properly perform a message transaction, full knowledge is required about the sender and the recipient. This is required to allow for optimal transcoding of the input message to the correct output format. However, there are cases where either the sender or the recipient (or both), are “not completely” known to the MMR. The data stored in the MMR database may be incomplete or inaccurate. For example, a user might be registered to the service, without the MMR knowing which device is being used. This information may also change when the user moves his SIM card from one device to another. In other cases, the user might not be registered in the database at all. The purpose of this module is to perform the correct logic decisions, to make the most out of the data that is known to the system. Furthermore, the sender and recipient logic are used to gather information about the system users in an un-formal way, by correlating information such as phone numbers, device user agent, and incoming message formats. This information is added to the information submitted by the user, during the registration to the service (which is not mandatory, but recommended). Further details are included in Section J.

On-The-Fly Data Collection

PM/EMS/MMS Capability (PM and EMS Input Disable)

When an unregistered or a partially known user sends a PM, EMS, or MMS message to an MMR recipient, the MMR can register the sender on the fly. The purpose of this action is to update the database, and add users on the fly. If the user was already registered, the MMR checks that the user's capability to send messages in this format is already known.

Updating the Users WAP Profile

When a registered user sends a WAP message to an unregistered recipient, this recipient receives an SMS notification. When the recipient enters the message page, his phone's User-Agent becomes known to the system. At this point the MMR can add the recipient as a new user, and assign the correct device to him. This function is also useful for registered users who are now using a new phone model. The database can be updated with the new user agent. Accordingly, other capability flags, such a PM and EMS might now change. The exact same description also applies for phones using HTTP (standard WEB) browsers—there too the browser specifies a User Agent.

Synchronizing the User Data and Device Data

At any given moment, the MMR database might hold information about the user and his mobile device. Since some of the message formats may operate by using the user's capability flags alone, some users may not have a registered device type for extended periods. When user's register themselves through a dedicated registration process, or when users enter a WAP session their device becomes known. At this point it is important to verify that there is no discrepancy between the user's capability flags, and the devices' capability flags. The synchronizing process forces the devices' capabilities on the user.

Selected Message Type Logic

This section explains the logic implemented in the MMR Logic Module, to select the correct message type for the recipient. The logic is divided into a case where the recipient is registered (at least with partial data), or when the recipient is unknown to the MMR.

For each transaction, this logic should bring the system to the following state:

There is a valid sender data structure.

There is a valid sender device data structure.

There is a valid recipient data structure.

There is a valid recipient device data structure.

The format of the incoming message is well defined.

The format of the required output message is well defined.

The flow of events required to carry out this transaction is well defined as discussed above in 4(a).

Selected Message Type for a Registered Recipient

The selected message type for the recipient for any transaction is effected by the following parameters:

A direct request by the sender for a specific message type.

The user's device capability flags.

The user's capability flags. (if the device is not known).

The user's preferred message type.

The device's preferred message type (if the user did not specify one).

The original message format.

The capability flags show if the user can accept message in the following formats: MMS/LEMS/SEMS/PM/WAP Flag.

Due to the information required before a decision can be made, the recipient's data must be known. The receiver data may either be known because it was stored in the database, or because it was temporarily created for this transaction, as explained in section 4(b). In any case, at this point there can no longer be a discrepancy between the user's capability flags and his device's capability flags.

Given that the recipient is known, the selected message type will be chosen according to the following logic.

If the sender requested a specific format, that format is selected. (Forcing the format by the sender may result in the message not being sent. This is not the normal mode of operation. In the normal mode, the sender selects “automatic” and the MMR decides the best format automatically.)

If the sender mode is automatic, the user's “preferred message type” is compared to the devices/user's capability flag. If it is a legal selection, the message is sent to the user in his preferred format.

If the user has no specific preference, and user's device data is the next dominant information according to the following logic:
If one of the optional formats of the device allows the message to be sent without being transcoded, that format is selected.
If the message must be transcoded, and the device has a “preferred format”, that format is chosen.
If the device data doesn't specify a “preferred format”, the best of the format options is selected according to the following order: MMS, WAP, EMS, PM.
If the user's device is not known, the user's data is the next dominant information according to the following logic:
If one of the optional formats acceptable by the user allows the message to be sent without being transcoded, that format is selected.
If the message must be transcoded, the best of the format options is selected according to the following order: MMS, WAP, EMS, PM.

Selected Message Type for an Unregistered Recipient

If the sender requested a specific format, that format is selected. (Forcing the format by the sender may result in the message not being sent.)

If the sender did not request a specific format, the message will be sent according to a default table. The default table will be able to select a default output format for each input format. This table will be configurable with a simple editor. Table 1 is an example of the default output format table.

A temporary recipient data structure is created with coherent information to allow the selected transaction to take place.
Input Format WAP WEB E-Mail PM EMS MMS
Default Output Format WAP WAP WAP PM EMS MMS

Table 1: Default output format table.

Transmitting Pre-Source Information to Server

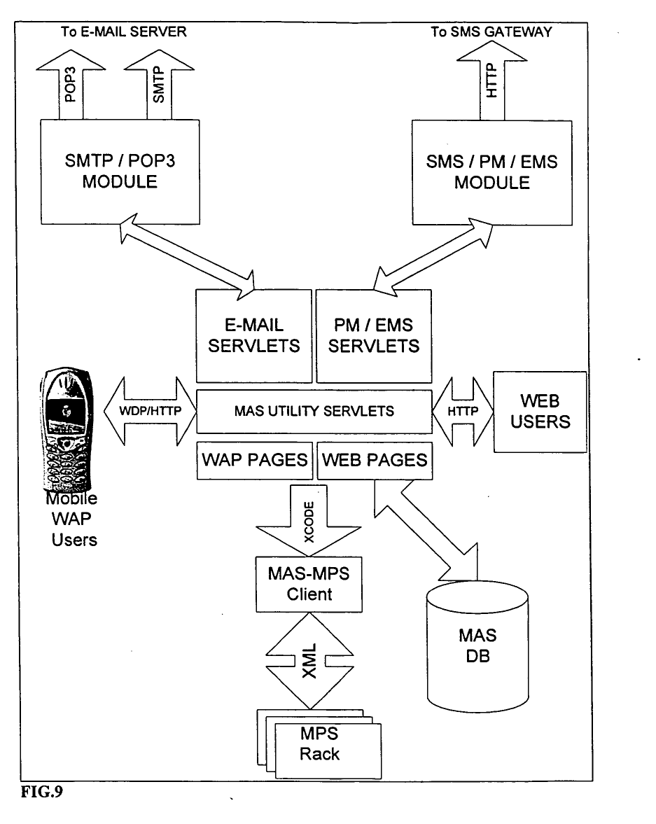

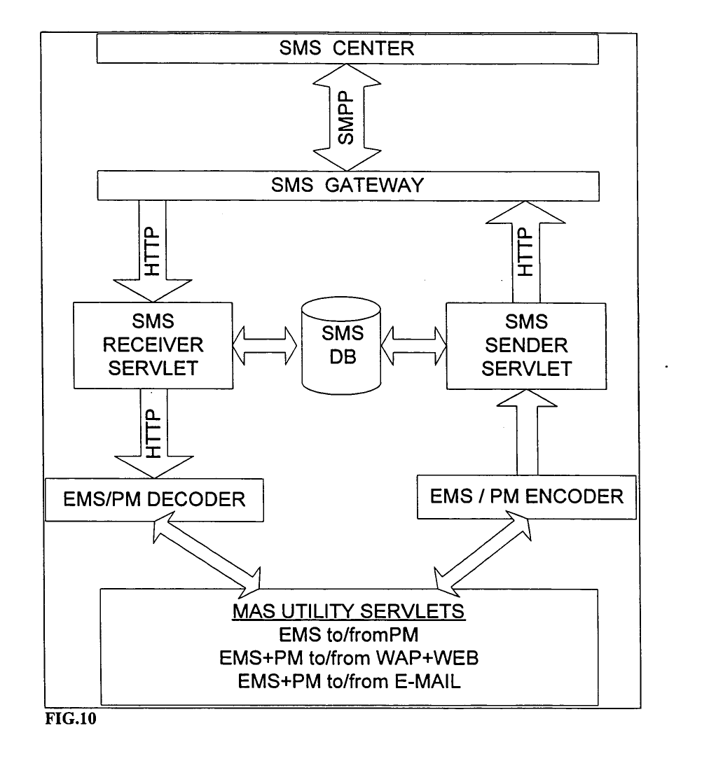

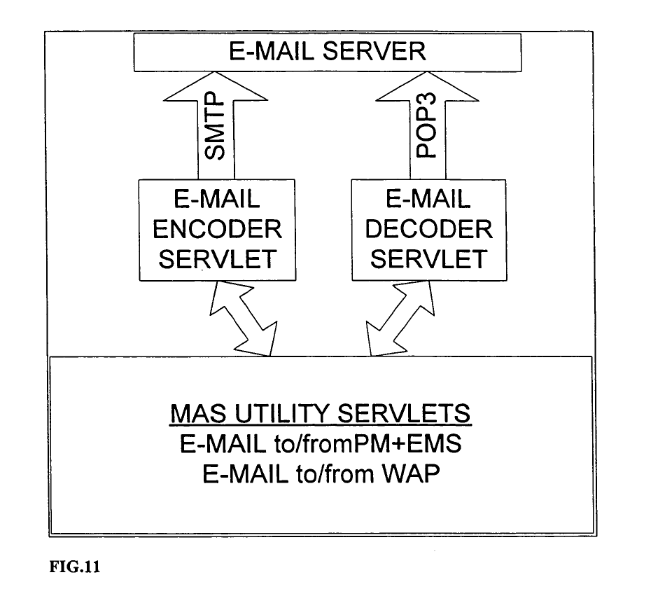

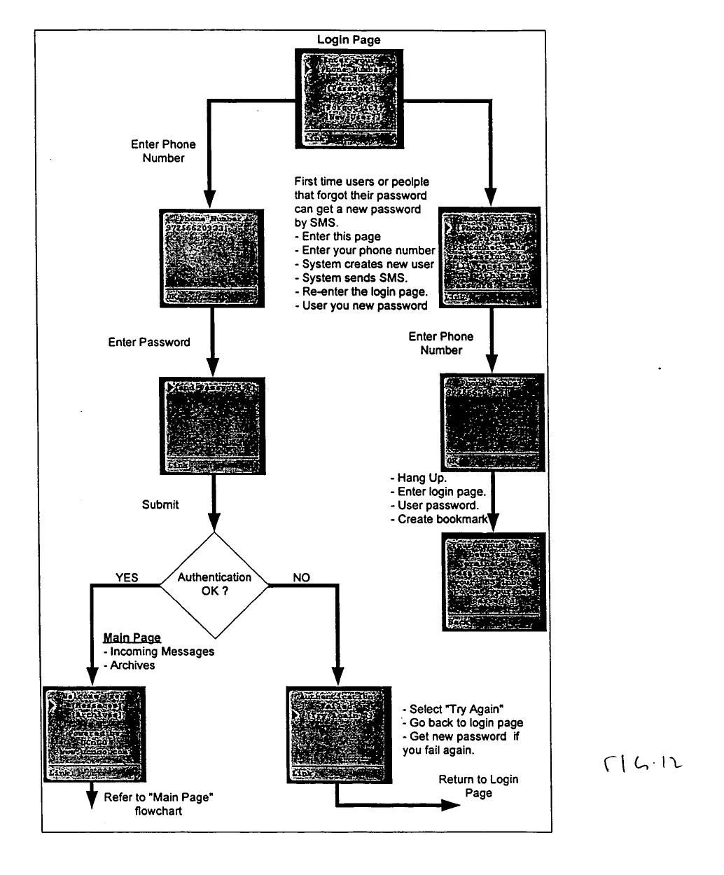

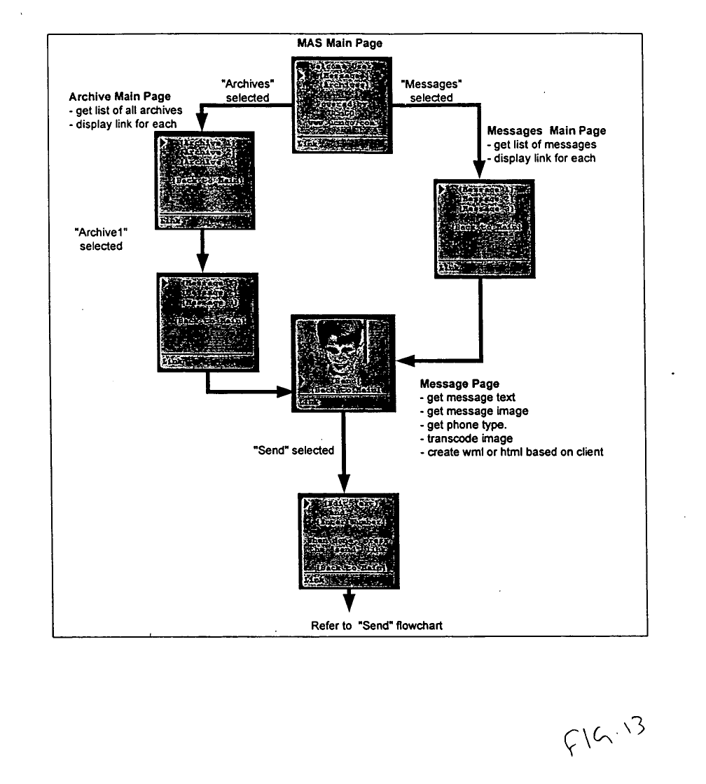

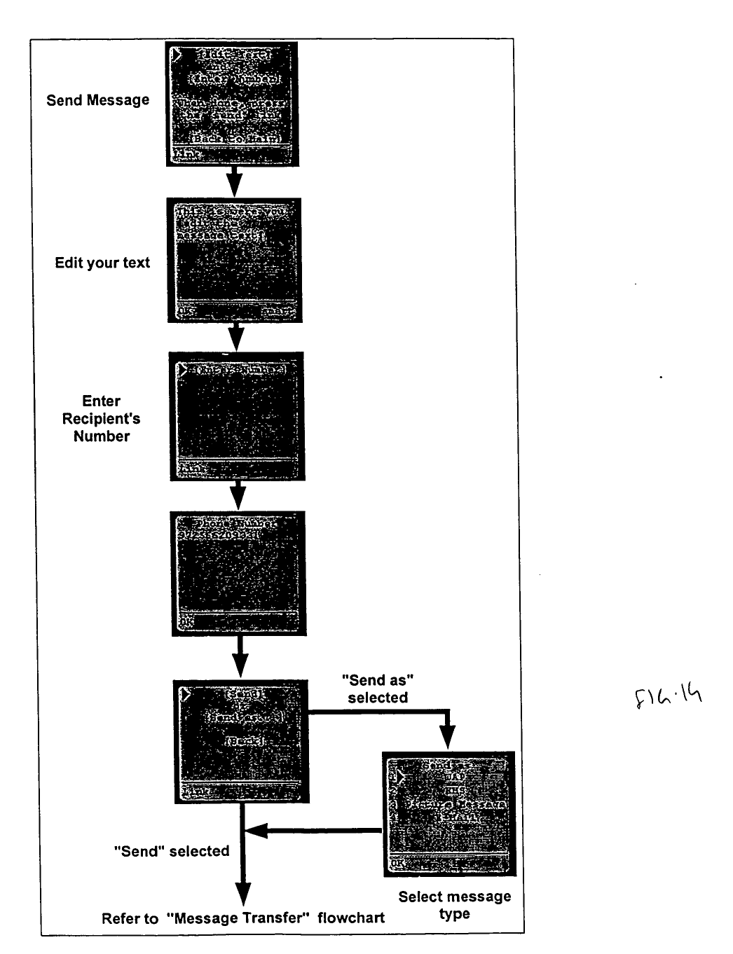

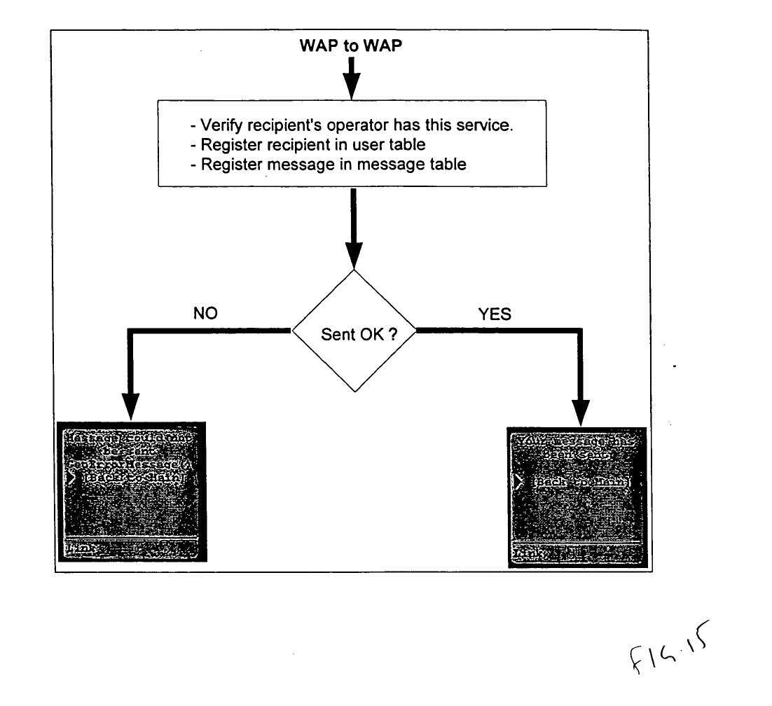

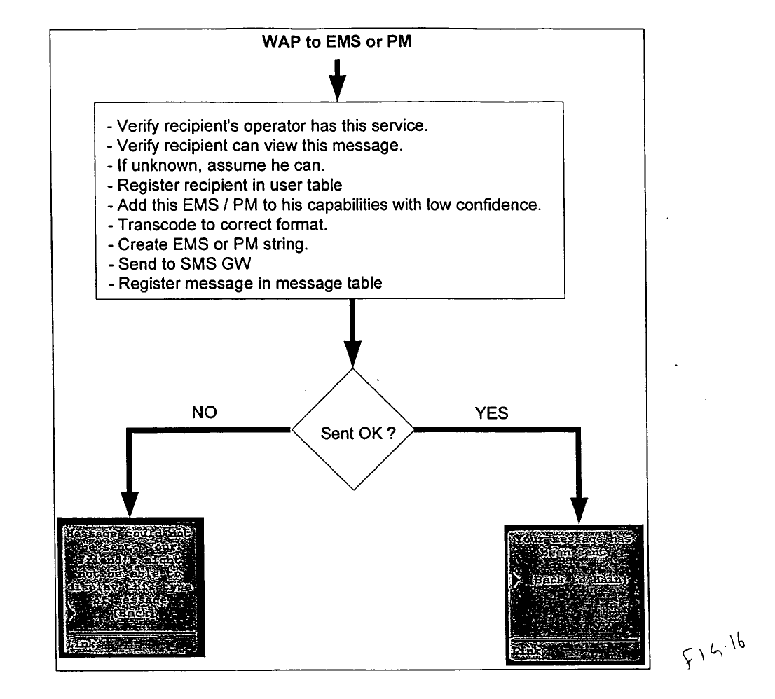

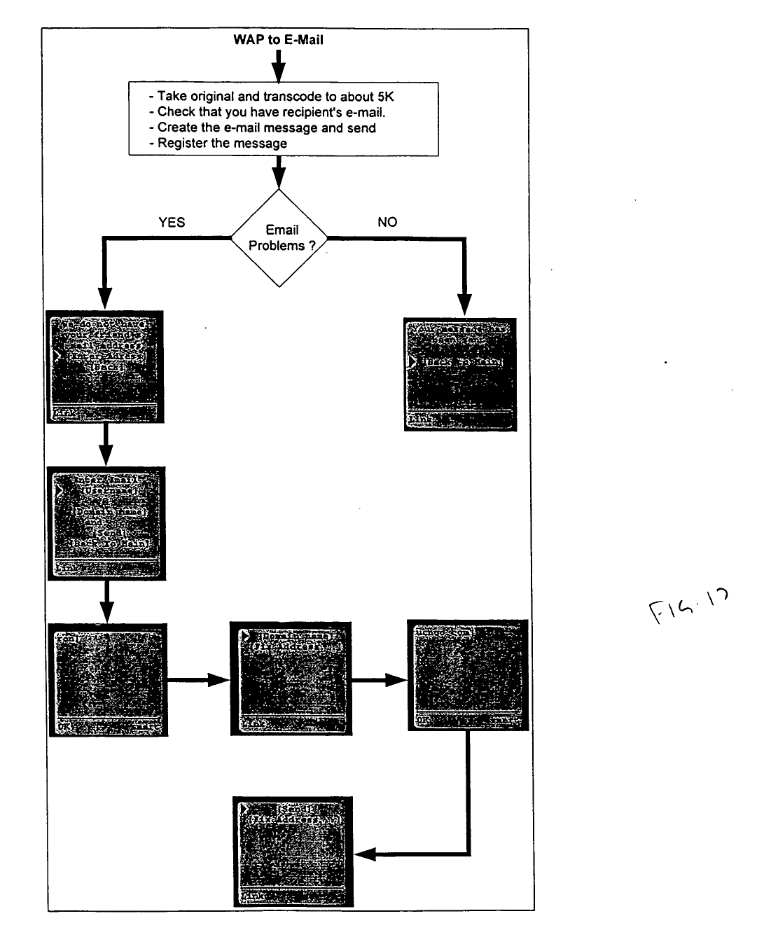

The pre-source information is transmitted to the server. The following description along with the FIGS. 9-11 referred to herein provides, to a skilled artisan, further explanation on the transmission of pre-source information.

User Control Web Page

This is a site that will allow users to change the attributes the system holds about their phones Authentication will be done as follows:

User enters a pages

Enters his phone number.

System sends an SMS with a 4 digit code to the user while he is surfing.

User will be able to change his phone type, EMS capabilities etc.

User pressed submits

System prompts the user to get the secret code from the SMS inbox.

User will enter the code and his registration details will be changed.

JSP Pages

The following sections are pseudo code descriptions of the JSP pages.

login.jsp

Enter your Phone number

Enter your Password

Struct userstruct=GetUserStructByPhoneNumber(number)

Bool lsvalid=AuthenticateUser(number, userstructpassword)

If (isvalid) Goto Mainjsp (2.3) else if (Try again ?) goto login.jsp

If (“Password” ∥“New users) Goto Forgotornewjsp

forgotomew.jsp

Enter phone number

Bool newuserok=adduser(number, useragent)

If (newuserok) Bool passwrdsetok=SetNewPassword(number)

If (passwrdsetok) userstruct=GetUserStctByPhoneNumber(number) Bool smssent=SendSMS(userstructepassword, number)

main.jsp

Bool gotmsgvect=GetUserlessageIdvectorlconst number, msgidvd)

If (gotmsgvect) numofinessages=msgidvect.size

Set number in the brackets (i.e. Messages)

Bool gotarchivevect=GetArchiveNameVect(archivevect)

Int numofarchives=archivevectsize

Set number in the brackets (i.e. Archives)

If “Messages” goto messagesjsp

If “Archives” goto archivesjsp

messages.jsp

for (I=0; I=numofmessages) CreateUnkToMsg(msgidvect[I])

if “Message” pressed, goto msg.jsp (2.5)

if “Delete All” pressed Bool deleteOK=DeleteAllMessages(msgidvect)

if (deleteOK) goto MessagesDeletedjsp, and then goto main.jsp

msg.jsp

msgStruct=GetMessageStruct(msgidvect[I]) (including GetImageFileID)

String msgtxt=msgStruct.txt

Vector<char>image_buffer=msgStruct.GetImageBuffer( )

DevStruct SourceDeviceStruct=GetUserDeviceByNumber(msgStruct.From)

String UA GetUserAgentStringFromSession( )

DeviceStruct TargetDeviceStruct=GetUserDeviceByUserAgent(UA)

XMLreq=GetXMLrequest=(SourceDevice, TargetDevice image_buffer)

XMLresponse=PostXMLrequest(XMLreq)

Out_image_buffer=GetlmageFromXML (XMLresp)

Output message.wml

If “Send” goto send.jsp

If “Delete Message” Bool msgdeleteOK=DeleteMessage(msgStruct.msgID)

If (msgdeleteOK) goto MessageDeleted.jsp, and then goto messages.jsp

send.jsp

Edit text edit box.

Edit number edit box.

If “Send as” pressed goto #sendas card. Select message type.

MsgStruct=CreateMessageStruct(From, To, type, text, imageFileID)

If “Send” Bool sentOK=SendMessage(msgstruct)

If sentOK goto sentok.wml and then goto messages.jsp

If ((!sentOK) && (type=wapwap)) goto sendfailed.jsp

If ((!sentOK) && (type=wapemall)) goto noemailaddress.jsp

If ((!sentOK) && (type=wapemspm)) goto notemsable.jsp

Noemailaddress.jsp

If “Enter AddressA goto Enteremail.jsp

Enteremail.jsp

MsgStruct.emailaddress=emailaddress

sentOK=SendMessage(msgstruct)

if “fix address” goto entermail.wml

archives.wml

for (I=0; I=numofarchives) CreateUnkToArchive(archivevect [I])

if “Archve” pressed, goto archive.jsp (2.10)

Archives.jsp

Bool GotVector=GetArcMessageIDVector(ArchiveID, msgIDVect)

for (I=0; I=numofinessages) CreateUnkToMsg(msgidvect[I])

if “Message pressed, goto msg.jsp

If “Delete All” pressed Bool deletOK=DeleteAllMessages(msgidvect)

if (deleteOK) goto MessagesDeleted.jsp, and then goto main.jsp

MAS-MPS Client

The MPS client block enables MAS serviets to use MPS transcoding services, as well as supplying an API for XML and Base64 functions. Listed below are the main functionalities of this block.

Encoding and Decoding of images from binary to base64 ascii.

Creating XML transcode request.

Posting XML requests to an MPS server rack.

Receiving and analyzing XML responses.

Handling MPS errors.

Details of Media Processor

The MEDIA Processor provides image processing and transcoding for purposes of image enhancement and terminal compatibility. Naive transcoding may result in unreadable content on the small screen of a mobile terminal. The Media Processor enhances the image to correct such faults when the content type is identified. the MPS also supports audio, ringtones, animation, video see for example AudioTranscode.

Communication with the Media processor is implemented using XML interface. The Media Processor reports success or failure for an entire message as well as for each individual operation of the message. The media processor supports processing multiple images within a single message.

At least the following media processing functions are available to render message images for display on user's device: Adaptation functions—media format convert—fom (Progressive JPEG, Baseline JPEG, JPEG 2000, GIF87, GIF 89A, WBMP, BMP, PNG, EMS, Nokia PM) to (Progressive JPEG, Baseline JPEG, JPEG 2000, GIF87, GIF 89A, WBMP, BMP, PNG, EMS, Nokia PM) including colour palette adaptation, all based on a client submitted device type parameter.

Image content selections are provided to identify the type of image (e.g.—Photograph, Face, Document (e.g. FAX), cartoon, Synthetic (e.g. chart), Panoramic (erg, scenery).

The MEDIA Processor includes a facility to smart compress images (VGA picture with smart JPEG compression takes maximum storage of approximately 50 k).

The Media Processor is capable of being shared by multiple clients.

Enhancement Functions

The media processor provides the following media processing image enhancement functions:

Brighten (dark), Darken (overexposed), Enhance, Colour balance, Remove Noise, threshold(local adaptive, standard), adjust levels, sharpen (radius, intensity, automatic), de-blur, smooth, histogram equalise, invert, flip(mirror), crop(arbitrary or parametric), Remove artefacts, resize(nearest neighbour, bi-cubic, bilinear, maximum/minimum neighbour, line preserving), salt and pepper removal, local illumination correction (arbitrary, emphasise edges), histogram equalisation, histogram manipulation, Brightness, Contrast, Colour modification, Rotate (90, 180 or 270 degrees).

Auto-Enhancement Functions

The media processor provides the following media processing auto-enhancement functions:

Auto level, auto crop, auto colour balance, auto image content type detection, Image classification and Optimisation Pressing Add text as graphic, add background, image manipulation (warping), image framing, combine images, Add objects (hair, eyeglasses etc.), Include image in postcard/template, Camera calibration for common mobile camera types.

Image Stitching

The media processor provides the following image Stitching stitch 360-degree panoramic and stitch tax. Full stitching 2 images/arbitrary-length series, Image pair matching, Image merging, given shift parameters, Image stitch/match given assumptions (e.g. horizontal only), stitch (Brightness, Contrast, Colour).

Advanced Functions

The media processor provides the following media processing advanced functions:

Detect face; detect eyes, OCR Recognition, Bar code Recognition, picture object recognition, Image recognition (e.g. content type recognition to permit optimal transcoding).

Watermarking

Watermark detect and add functions shall be provided for WBMP and JPEG images. A watermark shall support a minimum of 19 decimal digits.

Identifying Display Characteristics

The following code segment explains display characteristics identification.

```
- <target-device>
- <platform>
  <manufacturer>Ericsson</manufacturer>
  <model>R320</model>
  <ROM-revision>n/a</ROM-revision>
  <User-Agent>EricssonR320/R1A</User-Agent>
  </platform>
- <network-connection>
  <nc-type>GSM/CSD</nc-type>
  <nc-speed>9600</nc-speed>
  </network-connection>
- <target-display>
  <horizontal>88</horizontal>
  <horizontal-scroll>88</horizontal-scroll>
  <vertical>52</vertical>
  <vertical-scroll>110</vertical-scroll>
  <dpi>n/a</dpi>
  <pixel-ratio>1.24</pixel-ratio>
- <colors>
  <type>B/W</type>
  <number>2</number>
  <bit-arrangement>n/a</bit-arrengement>
  <palette-LUT>n/a</palette-LUT>
  <gamma />
  <brightness />
  </colors>
  <emstype>none</emstype>
  <pdu>1300</pdu>
  <maxwpdksize />
  <maxpixels />
  </target-display>
  </target-device>
```

Additional Processing by Media Processor.

The Media Processing Server (MPS) is designed to handle all media types, including formatted text, images, animations, audio and video, with an emphasis on advanced processing algorithms, In a nutshell, some of the following funcitonalites are provided.

1. Image Transcode Optimally convert content for a target phone. Automatically performs resizing, color palette reduction, compression, rotation, watermark detection and more, The transcode operation is controlled by a rule based system with configurable parameters for bandwidth utilization, format usage, Quality of Service and content preferences, Performs different transcoding operations based on automatic detection of the content type.

2. Audio Transcode—Similar to transcode for audio files. Useful for converting audio found on the internet to MMS phones. Also supports conversion of ringtones between the different formats existing today.

3. Video Transcode—similar to image transcode for video files. Also supports cross media conversion video to animation, video to still image, video to sound track.

4. Image manipulation package:

4.1. Rotate rotates an image by a specified amount with a selection of interpolation methods.

4.2. Resize—resizes an image with several interpolation methods including special modes for phone screen with a small number of colors/non-square pixel.

4.3. Brighten—enhances the image brightness—useful for dark images and for adapting to phones with a nonlinear Gamma curve.

4.4. Darken—decreases the image brightness—useful for over exposed images and for adapting to phones with a nonlinear Gamma curve.

4.5. Enhance—combines color and contrast enhancement of an image.

4.6. Color balance—performs color balancing of images taken by low quality cameras or in difficult lighting conditions.

4.7. DenoiseSpeckle—noise removal for low-light/noisy camera/data transmission errors situations.

4.8. Threshold binarization of images for B/W screens.

4.9. Adjust levels parametric contrast adaptation/

4.10. Sharpen—fast parametric correction of blurry images.

4.11. Deblur special sharpening for camera images taken in low light conditions.

4.12. Smooth—smooths a noisy images.

4.13. Histogram equalize—automatic contrast range enhancement.

4.14. Invert—performs a color/grayscale inversion. Useful for certain synthetic images on low contrast phone screens.

4.15. Flip—fast mirroring operation.

4.16. Crop—cut a part of the image.

4.17. ArtifactRemove—JPEG artifact removal. Useful for highly compressed JPEG images (e.g. those transmitted over wireless links).

4.18. DenoiseSaP—Salt and Pepper noise removal.

4.19. LocIllumCorrect—Correction of lighting non-uniformity. Useful for Images of printed text.

4.20. PremHistEq—advanced histogram equalization for images with dynamic range problems.

4.21. ColorPaletteAdapt—Reduce the number of colors in an image using a fast algorithm. Useful for image file size reduction/adaptation to phone screens with a small number of colors.

4.22. FaceDetect—automatically detects a human face in a frontal facial image. Useful for capturing the most important part of an image for display on a limited size screen.

4.23. EyeDetect—automatically detects the eyes+nose section of a frontal facial images Useful for capturing the most important part of an image for display on a limited size screen (egg Nokia Picture Message).

4.24. Add Text—Add formatted text to an image (with font selection).

4.25. Add Object—Add an object (hate eyglasess etc.) to a photo.

4.26. Add Frame Add a frame (several selections) to a photo.

4.27. Add Effect—artistic effects (warps sphere, twirl etc.).

4.28. Embed Watermark—embed a watermark in an Image/audio/video file.

4.29. Detect Watermark—fast detection of an existing watermark in an image/audio/video file.

4.30. Smart Compress—reduce the file size of the image/audio/video file to below a specified limit. Useful for reducing network bandwidth and for overcoming memory limitation in handsets.

The MPS supports in a single product the complete range of processing requirements for the full spectrum of future MMSC infrastructure users:

1. The phone MMS users composing and sending an MMS from a phone. In this scenario the primary need is for fast transcoding and automatic content type identification and processing. For example, images taken by a user with a camera-phone need JPEG artifact removal, automatic contrast and color enhancement and face/eye detection for maximum utilization of target display screen size.

2. The internet MMS user, composing advanced MMS messages from an internet-based interactive Multimedia Album. This user can play around with images and audio/video objects, add text/objects/frames to image, compose and use existing SMIL templates etc. Relevant functionality in the MPS includes support for interactive manipulation of images (adjust contrast, add formatted text, add a hat to a person in the image etc.), efficient storage of images (smart compress).

3. Advanced MMC scenarios, where a sequence of processing operations is performed on an MMS prior to sending for example, detect watermark, block/report to billing system based on watermark info, compress audio component to reduce total MMS size while maintaining overall quality, convert video sequence to animations etc.

4. Content providers these providers have large amounts of content with specific, detailed processing sequences based on their preferences/knowledge of the content characteristics. Such providers will utilize the more advanced options of functions such as Transcode, compress, color palette adaptation, embed watermark etc.

Transcoding

The main functionality of Transcode is to convert an image so it will fit into a target device while maintaining the best quality possible. In order to fit an image to a specific device, the main considerations are:

1. Resizing the image until it is small enough (In pixels) to fit the device.

2. Reducing the image's color/bit depths to the device capabilities.

3. Converting the image to the specified format typically this format should be supported by the target device.

4. Ensuring that the resulting file size does not exceed the memory limitations of the device.

The algorithm used by Transcode can be divided into three main stages, according to the above criteria.

Stage I: Resize-Fit

In this stage the image is resized to fit the target device. For better quality, other image attributes (like bit depth) are not reduced yet (actually they may even be enhanced). Different variant of the resizing algorithm are used for different contentType values. Some parameters that may influence the result of this stage are:

Device dimensions, scroll-size, maximal allowed pixels, etc.

Source and target aspect ratio of pixels

The choice whether to use just the physical screen or the full scrollable screen—this is controlled by a configuration parameter, but overriding it in the XML-request is possible (useScroll).

The option to rotate the image by 90 degrees in order to get a larger view (rotatetobest)—the default value allows rotation for small-screen devices only (cell phones vs. PDAS, PCs). This may be changed in the configuration or the request itself.

Stage II: Color Fit

At this stage the image's bit depth and color space (i.e. color to gray) may be reduced in order to best fit a device. (For example, a color image with 24 bits of data per pixel may be reduced to a grayscale image with 2 bits of data per pixel in order to fit a screen that has only 4 gray levels).

The image is run through a series of specially designed filters that maintain maximal image quality while reducing the bit depth.

Specifying the contentType of the image can also control the behavior at this stage. For example, a lineart-type image is treated differently here, with filters that are designed to preserve as much detail as possible of lines and shapes, as opposed to a face/object image, in which the processing involves sharpening of facial features, or “scenery” photo-type image, in which the main point is to preserve color and brightness accuracy as much as possible.

Stage III: Creatine the Output File

When the image has reached its final size and depth, it must be converted to the format requested (after making sure it is supported by the target device). This stage could have been straightforward, but we must also make sure the file is small enough for the device's memory to handle. In some cases, after the file is created, it may be necessary to repeat the previous stages and create an even smaller image, until the file size itself is small enough.

Other Stages:

Stage 0 in contentType=“document” consists of local thresholding.

Reiteration of the process with stricter limitations if the output file size is too large.

Watermarking

Watermarking (WM) consists of embedding hidden information within media files/objects, which may be used as part of a digital rights management system (DRM)—for billing, copyright, content-blocking etc. The information content of the watermark in MPS is defined as a 19-digit numeric string, excluding 0 (i.e. I<=WM<1019).

Currently watermarking is supported for the formats jpeg, gif and png and is performed by hidden comments—for jpeg and png, these comments won't be visible through typical viewers. But it can also include watermarking of B/W at the image level, regardless of the format. The typical scenario for watermark usage is through devices that do not normally manipulate images, but may send images previously received from an MPS system without tracking information.

Watermark Functions:

EmbedWatermark—This function is used to embed the watermark (numeric string). It can be used only when the specified output format is one the supported WM formats.

DetectWatermark—This function detects the MPS watermark embedded in an image/media files it is relevant only for WM-supported input formats. Note: The output of this function differs from typical MPS output—it is the watermark (or ‘watermark not detected’ message) and not an image.

RemoveWatermark—This function is used to clear the watermark from an image. Note: This operation may happen as a side effect of most methods for some formats/implementations.

It should be noted that currently the watermark functionality is designed mostly for demonstration and evaluation purposes. When integrated as part of a well-defined DRM system, watermarking functionality may include:

Method X+PreserveWatermark: To maintain the identification of an image after transcoding/basic manipulation, an alias of the following combination may be used—DetectWatermark->wm; method-X; EmbedWatermark (wm).

Method X+ManipulateWatermark: Another possibility is that the output-watermark will have a different value than the input-watermark, either by applying some mathematical function to it, or by the some DRM component that will issue a new value and maintain a log of the relationship between these values.

Overview of image Processing Algorithms

The system introduces a large number of image processing algorithms designed for:
1. Image adaptation and manipulation
2. Illumination correction
3. Noise reduction
4. Sharpening

This grouping of methods is for the survey convenience only. The methods are simple enough to allow good definition of the parameters involved. Each method deals with common problems, relevant to image processing implementations. Still, the full collection of these methods does not allow dealing with complex problems, which are addressed by transcoding, premium and advanced packages. In complex scenarios it may be difficult to choose appropriate methods, for correcting the problem without introducing undesired side effects which may degrade image quality to an undesired level.

Common Features

Color Treatment

In the image manipulations, denoising and sharpening functions the colors are treated independently. This means that each method is well defined for grayscale images. Thus it is applied with the same parameters 3 times, once for every RGB channel. There is no essential difference in handling the indexed images vs. the continuous color/grayscale images. Such treatment of color channels is simple and intuitive. It allows better understanding and description of the parameters involved. More elaborate color space treatment shall be implemented in the context of premium package scenarios.

In the illumination correction functions there are usually 2 modes of implementation with separate colors parameter acting as selector. When set separateColors=false, the method would handle all channels in a combined manner.

Smoothing Kernels

Some algorithms included (noise reduction, sharpening etc.) use linear convolution with a predefined kernel as the main processing tool. The most common convolution is convolution with a simple Gaussian kernel. However, using convolution kernels with other shapes might improve the performance of the algorithms.

The algorithms which are not very sensitive to the kernel parameters use Gaussian kernel with standard deviation automatically calculated from the effective radius.

The algorithms which are sensitive to the kernel parameters use one of the following shapes:

1. ret—Rectangular shape is the most common, since it allows very fast computation. The problem with this kernel is its emphasis on diagonal edges, which are seldom present in the image.

2. diamond—This is a rectangular shape rotated by 45 degrees. The best feature of this shape is its ability to emphasize horizontal and vertical edges of man-made structures and geometrical objects. The other reason for emphasis on horizontal lines is the fact that they are hardly influenced by discretization process.

3. ellipse—Circular, or more generally elliptic kernel treats in the same way structures of every orientation. This is a more general-purpose kernel, used with natural images.

4. softEllipse—In ellipse the edges are hard-threshold, either 1 or 0. In softEllipse the edges can have a value between 0 and 1. This allows a better approximation of disc shape. This feature is suited for linear operations and may cause artifacts with non-linear filters (median, contrast stretch etc).

5. gauss—This stands for Gaussian filter, e.g. “gus0707*, “gaus0505” and “gausAuto”. The later two indexes stand for the standard deviation value of the Gaussian in each direction. The recommended setting “gausAuto” automatically calculates sigma based on the radius of effective coverage of the Gaussian. The Gaussian kernel allows graceful degradation of the pixel weight far from the center of the smoothing kernel. This feature is ideal for linear convolution.

6. kX—Eg. “k1” and “k2”. Reference to bank of pre-defined kernels to be used in special scenarios. This is a ‘premium’ interface and there is no meaning to kernelWidth and kernelHeight.

It is possible to use prolonged kernels to emphasize the horizontal and vertical edges. For this purpose separate parameters are defined for kernelWidth and kernelHeight rather than radius.

Fine-tuning kernels for images and algorithms can be a tedious task, therefore some basic recommendations are given where possible.

Image Adaptation and Manipulation

The elementary image processing operations deal with image size and orientation. These functions, namely Rotate, Resize, Flip and Crop, are available in every basic image manipulation package. Threshold, Compress (with GIF output) and invert methods are used to adapt the Image to the display color palette and minimize the use of target device memory space. Resize and Threshold provide advanced modes—which perform more sophisticated processing.

The methods in the basic image manipulation package can be optimized for speed, and can include platform specific speed-ups in all platforms (Intel, Solaris, etc).

In addition to providing an image manipulation package, these functions enable advanced compression and building your “home-made transcode”. Typical variations of such experimentations with transcoding consist of a sequence such as crop->resize->compress, or crop->(optional) rotate=>resize>quantization/threshold—to adapt large images to small displays. Crop allows spending all of the limited screen resources on the main object; resize minimizes the information contained in the picture and compression/quantization discards less-important information. Rotation is used to use the display dimensions and aspect ratio as best as possible. On some media the image has to be inversed prior to display (e.g. scanned negatives).

Color Palette Adaptation

ColorPaletteAdapt fits the image to a limited palette. This is useful either when the device or file-format has a limited color capability or when file size is an issue. Once the palette is defined, each pixel is assigned a value from it: this is done either by assigning each pixel the nearest value, or dithering—a method which increases color resolution at expense of spatial resolution. As default dither is used when the specified number of output colors is small, but the user may explicitly specify whether dithering should be used. Dithering is not recommended when output file size is a major issue, but is recommended when the device color capability is the issue. Note that ColorPaletteAdapt with paletteName=“B/W” is equivalent to threshold with the default parameter, for B/W adaptation one may prefer using advanced modes of Threshold.

Threshold

Threshold converts a grayscale image into a discrete S/W Image. It may used as part of other more complex conversion operations (e.g. Transcode), and can serve for artistic effects or image combination effects. For example: converting a formatted b red text image into S/W before sending to a B/W screen, reducing the color content of a single layer (e.g. object for combining in an image) so it will not add to the color palette of an image etc. It allows explicitly controlling the threshold level, automatically finding the optimal global threshold, or applying a local threshold (mode localV2 is usually interior to local).

Compress

The method compress attempts to reduce file size without changing the image size. It may achieve this goal by more efficient coding, reducing colors and losing some details. In some case it may follow an operation intended to reduce the image size it is wise to apply compress in combination with an efficient image format (i.e. jpeg/jpeg2000 for storage, gif for most devices).

This function has a different implementation according to the requested output types. The problem of file size is important in several aspects: Most of the currently available phones/hand-held devices have limited capacity, both for single file and in total. Bandwidth in cellular networks may also be an issue. In addition, in messaging system storing many millions of MMS messages, the typical file size becomes an issue to consider too. On the other hand most images entering the system may not be limited to the few-Kbytes range suitable for hand-held devices.

The palette and processing power limitations of currently available hand-held devices makes the compression utility especially relevant for image/gif output mime type.

In this case compress activates adaptive quantization procedures which provides for a clear image with minimally reduced color palette. Detail reduction, image resizing and cropping are not supported by the compress method and require dedicated requests.

The implementation of the algorithm is based on adaptive reduction of the color palette and smoothing for GIF/PNG Images, and on JPEG DCT quantization table variation and smoothing for JPEG Images. The parameters are changed iteratively until the maximum quality setting with a file size under the limit is reached.

It is important to know that if the target file size is too small, the algorithm will return an error message. This reflects the fact that even under a color reduction to a bitonal image the file size under the given compression method was too large in this case the image should first be resized, then compressed.

The parameter available for this function is maxSize, which is the maximal allowed image size in bytes. For a CIF sized image, to be displayed on a typical hand-held device, some recommended sizes are:

| Image/Device type | MaxSize (bytes) |
|---|---|
| VGA image - storage | Up-to 50000 |
| Lineart/MMS message | 4000 |
| Lineart/WAP phone | 1400-2000 |
| T68/WAP client | 2300 |
| Natural Image/PDA with MMS/email client | 8000 |

Invert

Some image sources (e.g. scanned negatives) and output devices require image inversion. The inversion is performed for each color channel separately, so that yellow is transformed to blue, white to black etc. This is a simple function so it does not require any parameters it is most useful for e.g. synthetic images displayed on low contrast screens.

Rotate

This is a standard implementation of image rotation. The parameter specifying the amount of rotation counter-clockwise in degrees is mandatory, Values out of 0-360 range are corrected by the algorithms, so that −90, 270 and 630 degrees rotation have the same effect.

For angles other than 0, 90, 180, 270 the output pixels of the original image are not a rectangular image, this poses a choice of what rectangular image should be returned and what should be the values of the pixels not present in the input image (in 90, 270 the size changes—width <-> height—but there is no dilemma defining the output image). The parameter mode determines the output size: mode=full returns the bounding block image of the rotated input image, mode=crop crops the rotated image to the size of the original image (with the same center). The portion of the output image, not present in the input is always padded with a black background. For rotation by multiples of 90deg both modes provide the same output.

The interpolate parameter allows to choose the interpolation techniques interpolate=billnear is usually a good choices it is computationally efficient and does not introduce large artifacts. Selecting interpolate=bicubic provides for a more sharp and accurate image at cost of computational efficiency and ringing artifacts, interpolate=nearest selection is most efficient computationally and does not alter image palette. However it may introduce some aliasing artifacts. This parameter is also ignored for multiples of 90deg.

Resize

This speed-optimized function serves to change the image size. It can be used to fit an image into a small phone screen, or to reduce an image size prior to compression and storages For example, an incoming 3 mega-pixel image from a high-quality digital camera may be resized to VGA (640 by 480) size prior to PEG compression and storage, in order to reduce storage space requirements.

The mode parameter selects the interpolation algorithm. Beside the usual bilinear, bicubic and nearest methods, proprietary methods are supported to provide for optimal performance with various image types and target devices.

Flip

Flip the image horizontally (vertical=false) or vertically (vertical=true). For an upside-down one should call this method twice, each with a different parameter value (or call Rotate 180 degrees).

Crop

Crop may be used when the final image size is limited and the more significant details are concentrated in a limited region of the image. Cropping most of the background allows applying a more moderate resize. After the application of crop method a rectangular area ‘cut’ from the original image is returned. Crop's interface is the following
top—the upper bound of the image, range: I-ImageHeight
bottom—the bottom bound of the image: top-ImageHeight
left—the left bound of the image: I-ImageWidth
right—the right bound of the image: left-ImageHeight

The coordinates start from the top-left corner of the image with coordinate (1,1), rather than (0,0) used in some other commercial software. The rectangle specified by the four parameters has to have a positive area, so left <=right, top<=bottom. The edges are included in the rectangle.

Illumination Correction and Color Manipulations

The illumination correction is one of the more difficult problems in image processing. There are many ways to correct for improper illumination/detector problems. Basic solutions work only on a small range of imaging situations. The methods given below are just the most simple and intuitive tools, while the premium package contains more complex and elaborate algorithms to deal with the problem.

The AutoLevel method with empty radius parameter is perhaps the most powerful algorithm available in the basic package.

Darken

This method darkens the image, and has two modes:

If intensity is not specified, the function performs a darkening which may be described as the dark half of AutoLevel.

If intensity is set, the image is darkened by the specified amount (intensity: [range: 0-1 (0—do nothing, 1—maximal)]), When intensity is 1, all mid levels become black and only colors white (or brightest level in channel X) remains as it was. Darken with intensity X is equivalent to Adjust levels with contrast=0, brightness=−X.

Brighten

This method brightens the image, and has two modes:

If intensity is not specified, the function performs a brightening which may be described as the brighthalf of AutoLevel.

If intensity is set, the image is brightened by the specified amount (Intensity: [range: 0-1 (0—do nothing, 1—maximal)]), Brighten with Intensity X is equivalent to Adjust levels with contrast=0, brightness=X

AdjustLevels

This method gives the user full control and responsibility of the output. Both parameters are mandatory.
brightness: [range: −1-+1 (−1=black, +1=white), recommended range: −0.3-+0.31
contrast [range: −1-+1: (−1=monotonic image, +1=pure color image), recommended range: −0.3-+0.3]

For positive contrast values, first the brightness is adjusted and then the contrast. For negative values, contrast is adjusted first. The effects of both these operations is accumulated, so the maximal effect when the contrast is positive is the sum of the contrast value and the absolute value of brightness. This sum should not exceed 1, or be too dose to it (i.e. contrast=brightness=0.6 will result in a white image, just like brightnes=1).

AutoLevel

This is the primary function for illumination correction included in the basic package. The global AutoLevel (empty radius parameter) maximizes image contrast, discarding the outliers of very high and very low intensity. This is especially useful for images taken in the haze, rain etc.

The local AutoLevel is activated, setting some positive radius parameter. The recommended radius values are in range [10-30]. For small radius values the image appears grainy. Unlike the global AutoLevel, the local AutoLevel stretches the contrast w/o outlier detection. This effect is achieved if used after DenoiseSaP.

The separatecolors=true setting allows illumination/color correction as well as luminance correction.

ColorBalance

This function tries to produce truly colorful images, by increasing the contrast in hue domain. Thus a white object on a blue background will appear yellow. This method is similar to the correct illuminant effect in vision. On most natural images the effect is very small. Setting mode=1 is mandatory. The level can vary in range [0-1] with default 0.5. Both parameters are mandatory.

WhiteBalance

This function calculates the mean value of the gray pixels in each channel and brings it to 0.5. The pixel is reported as gray if its color in all 3 channels obeys abs(pixel_value-0.5)<tolerance. The tolerance is a user-supplied parameter with default value 0.15. The color correction is a gamma correction, with automatically calculated parameters for each channel.

ColorVariations

This is a two-stage function. In the first stage the gamma of each color channel (e g, red, green, blue) is changed according to intensity value between −1 (remove color) to +1 (saturate color). In the second stage the saturation of the color is changed by changing the Euclidian distance between each channel value and gray image value, such that −1 stands for grayscale and 1 stands for saturated colors.

For a simple cmos based camera such as the Communicam it is usually recommended to put
red=0.2
green=0.2
blue=−0.1
saturation=0.3

HistEgualize

This method performs Histogram equalization (no parameters). The resulting image has a uniform histogram (as much as possible considering the input color distribution). This is a common solution illumination correction, but it has side effects, such as eliminating the real color distribution of the image (e.g. adaptive thresholding of the result of histogram equalization, is likely to have poor results).

PremHistEq

Unlike the HistEqualize, PremHistEq trades off the speed and simplicity for the flexibility of operation. It has a large set of parameters and modes of operation which have different effects.

P-law histogram equalization allows a trade-off between simple histogram equalization (pval=0), no effect at all (pval=1), dominant modes emphasize (pval>1) and dominant modes destruction (pval<1).

The recommended values are

Pval Scenario
0.3 Histogram equalization of moderate intensity
0.7 Histogram equalization of small intensity
1.5 Posterizatlon
−0.2 Histogram equalization of very large intensity

Local histogram equalization allows histogram equalization on blocks of limited size. The recommended size of the block is in the range 0.2-06 of the image size.

Number of histogram bins has quantization effects For pval<0 it is recommended to use at least 32-64 bins. The algorithm uses linear interpolation between bins.

LocIllumCorrect

This method performs local illumination correction and has a large amount of sub-methods chosen by correctionType. Other methods which locally correct the illumination level are AutoLevel (local) and, for binary output, the local mode of Threshold. This procedure is effusive for non-uniformly lighted handwritten and printed text as preprocessing to advanced applications, such as OCR and feature detection, but it may sometimes degrade the visual quality of the image as perceived by humans. Some safety mechanisms were introduced to limit the visual degradation of the image. One of this mechanism is setting separateColors=false to preserve the original hue of the image.

The LocIllumCort can produce unexpected results with images with very limited color palette (16 colors and less).

GlobIllumCorrect

The global/block-wise illumination correction allows automatic correction of image curves with the following sub-methods chosen by correctionType:
gamma—gamma correction, so that the mean value of the image is 0.5 (gray),
curve—a variation of gamma connection with highlights and shadows subjected to separate gamma values.
contrast—synonym for AutoLevel. The addition functionality is bloc wise processing.
histEq synonym for PremHistEq with different interface (number of bins and power is selected automatically).

The correction is global, unless blkHeight and blkWidth are both set. The recommended block size is 64×64 or 128×128. The blocks overlay, so that their borders are virtually invisible for block size larger than 32×32. The separateColors parameter allows to select color channel treatment. Usually separateColors=true provides for desired color correction.

The GlobIllumCorrect can produce unexpected results with non-photographic images (erg lineart) and images with very limited color palette (16 colors and less).

Enhance

This function performs a selected combination of methods based on enhanceType parameter.

If the enhanceType is empty the function performs mild color balance+contrast enhancement it can be used safely on various input images and should improve many of them. The effect is similar to ColorBalance followed by AutoLevel (global).

If enhaneType=communicam, batch processing is executed using:
ArtifactRemove=>Deblur=>PremHistEq=>Crop=>ColorVariations=>GlobIllumCorrect. This processing is essentially acceptable for various JPEG input images, but most suitable for communcam output images.

Noise Reduction

The two most common types of noise treated by the basic package are:
1. White Gaussian noise/speckle noise
2. Salt and Pepper (S&P) noise

White Gaussian noise appears as an intrinsic part of the cheap camera detectors, especially in low illumination conditions it is inaccuracy in the pixel values—for many pixels. This is the most common type of noise, which appears on most of the images.

The S&P noise, is a small number of pixels having big “errors” in their intensity levels it appears as a result of interlacing/aliasing in the detector, faulty detector, sharpening of degraded images, communication problems, poor JPEG compression, scanning of analog photos. This type of noise is more rare and easier to treat than the Gaussian noise.

Since the noise appears independently in each color channel, the noise reduction procedures are independently applied to the color channels.

The noise types defined in this procedure do not have clear meaning in line-art images, therefore a natural image source is assumed. For indexed images a rich color palette is required.

Smoothing

The most common and simple way to deal with noisy, over-sharpened images and compression artifacts is smoothing. Smoothing is performed by a simple procedure of convolution between the original image and a Gaussian kernel.

The output of this method is a smooth image, where the degree of smoothness increases with the optional intensity and radius parameters.

Since there is no common scenario for the use of smoothing method, there are no clear recommendations about the smoothing parameters. For medium smoothing which does not degrade image significantly we can recommend intensity=0.5, radius=3.

DenoiseSpeckle

This is essentially an empiric Wiener filter. It essentially uses algorithm developed by Lee (1980) with minor modifications. The main modifications include a bank of smoothing kernels, the overfilter parameter and regularization process.

This de-noising procedure is essentially a local adaptive smoothing procedure, where the overfilter parameter plays the role of smoothing intensity, and the smoothing kernel selection plays the role of radius in the smoothing method.

DenoiseSaP

This is a standard 2-stage procedure of outlier detection followed by their replacement with local median. Changing the threshold influences the detection rate increasing the threshold will allow under-smoothing, while decreasing the threshold will allow over-smoothing. It is recommended to work with kernels of 9-25 pixels.

Sharpening

On most amateur photos the image is not sharp enough. The common reasons are: bad focus, motion blur, JPEG compression To increase the sharpness of the image one can use a sharpening procedure.

Sharpen

This function implements a standard unsharp masking procedure (which is equivalent to smoothing with negative intensity) if edges=false. In this setting the function increases the noise in the image, which is usually not recommended with originally noisy images. Setting edges=true will result in sharpening only over the edges, which is a preferable mode of operation. In this mode the radius parameter is ignored. The level of sharpening can be controlled by the intensity parameter.

ArtifactRemove

This function deals with heavy JPEG artifacts only. The artifacts are listed below:
1. Blocking: various sharp borders between 8×8 tiles
2. Ringing: high frequency moir noise in 8×8 tiles
3. Color spill: color channels not coinciding with luminance channel
4. Blur: high frequency edge blur

The ArtifactRemove method with deJPGtype=detail settings does not degrade the image visual quality. This is a general-purpose tool, which can be used for any JPEG input. However, for any specific problem it is recommended to use the dedicated method instead.

Deblur

Most of the digital photos taken by low-quality cameras appear to be out of focus or blurred. Simple sharpening does not solve this problem completely, especially in the noisy environment. Some off-the-shelf products (e.g. Extensis Intellehance) suggest blind deconvolution with adaptively selected kernel. The kernel is selected, so that maximal sharpening is achieved with minimal ringing artifact. While this method is implemented deblurType=defocus, it is not recommended in most cases. In the presence of noise and JPEG artifacts, the proprietary deblurType=premiumSharpen method proves to be more consistent and does not degrade image visual quality. The main difference between Sharpen and Deblur (premiumSharpen) is the use multiple kernels and homogenization as a part of sharpening procedure. For more sharpness one can use deblurType=premiumSharpenMore.

Functional Description of Audio Transcode

The support of multiple input and output format, optimized for the specific device, is as important in sound processing as it is in image processing. The main sources of audio are MP3 and WAV files, available on most PCs, disks and internet sites. These formats allow very rich sound at the expense of the disk space. The transmission bandwidth and memory of the hand-held devices is very limited. The audio capabilities of these devices, don't always make use of the richness of the input formats (e.g. stereo) More efficient compression techniques (e.g. GSMAMR) have been defined in the context of MMS for playing/recording audio on these devices. The audio transcoding process performs the following tasks
1. Down-samples and compresses rich audio files (MP3,WAV=>GSMAMR)
2. Masks compression artifacts and allows to play compressed files on PC (GSMAMR=>WAV, eft=mask)
3. Converts GSMAMR files from abundant to minimal compression rates and vice-versa (GSMAMR=>GSMAMR)
4. Supports Unix audio standards (AU to anything and anything to AU)
5. Adds effects to audio files (via the effect string) for audio quality improvement without issuing a separate request.
6. Automatically selects the conversion method via the mime type.
7. Performs ringtone conversion between Nokia Ringtones (part of the NMS standard) and iMelodies, TDD polyphonic tones (part of EMS standard and extensions to it respectively).

Other Specific Enhancements

Using the MMS Box as a WAP Site

WAP terminals have a built-in WAP browser. It is possible to go to a Web site with the terminal, and call down relevant information. The server will process the information called to optimize it for display on the terminal, and the processed information will then be transmitted to the terminal for display. This information may or may not be processed further by the terminal or by the server, according the user's request. Information which has been processed (either once or twice) may then be stored, in the terminal, or at the server, or at another information storage place specified by the user. Transmission to and from the terminal may be by wireless or wireline communication.

Converting a WBMP Into a Picture Message

WBMP is the WAP protocol for graphics. Images on the terminal may be displayed in PM format, not WBMP. The server may receive a WBMP image, convert it into the PM format, and transmit the message for display on the terminal. This conversion is new because the protocols WBMP and PM are both new, and therefore the conversion has not been performed previously.

Converting a WMBP Image into an EMS Picture Message

This innovation is exactly the same as converting a WBMP Into a picture message described above, except that the target format for display is EMS rather than PM. It will be appreciated that images may be converted into any number of picture formats, be it PM, EMS, or a different picture format to be devised in the future, such as Smart Messaging. The algorithms in the server make this transcoding possible. Again, this is new because the protocols, WBMP and EMS, are both new, and therefore the conversion has not been performed previously.

Human Face Recognition and Display

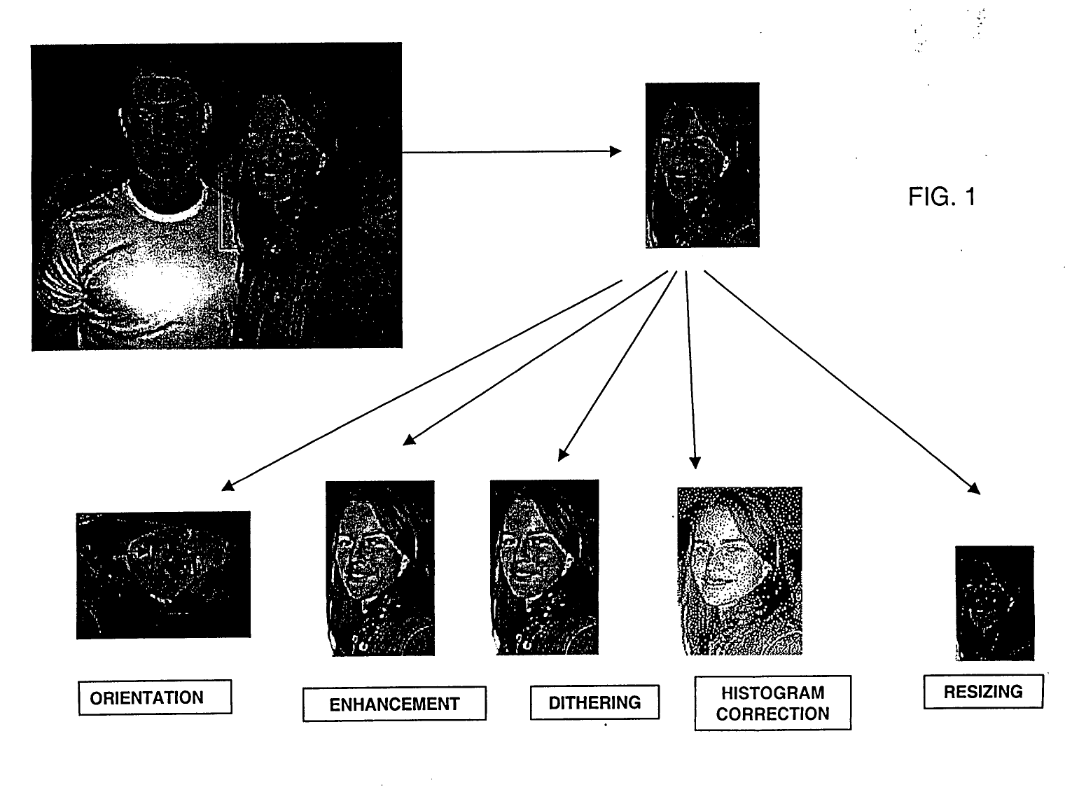

Refer to FIG. 1 attached to and incorporated into this application. In the picture, the woman's face may be recognized by algorithms defined in prior art. The invention includes innovative algorithms resident in the server which allow the server to process the relevant part of the picture, in this case the woman's face, for display on the terminal. There are three types of algorithms. The first is orientation. The face is oriented vertically, which means that the vertical dimension of the relevant part of the picture is greater than the horizontal orientation. Some terminals have display screens that are wider than they are tall. To capture the full image on one screen would require a reorientation of the woman's face from verticl to horizontal. The server knows the display characteristics of the terminal, and will perform this orientation.

The second kind of algorithm is “resizng”. Terminal displays are generally smaller, often much smaller, than the source image. The server will know these characteristics, and will accordingly resize the picture for display on the terminal.

The third group of algorithms is those which will reproduce the image on the terminal's display, while maintaining the integrity and quality of the image as much as possible. The need for these algorithms arises from the small display screen, or from the inherently lower resolution of the terminal display, or from other reasons. The server will know the characteristics of the terminal display, and will apply the correct algorithms for maximum effect. Examples of such algorithms include enhancement, dithering, and histogram correction.

The application of any or all of these algorithms to handset displays is innovative. The use of prior art face recognition as part of the system and method described herein is also innovative.

Face Binarization

Faces to BMP

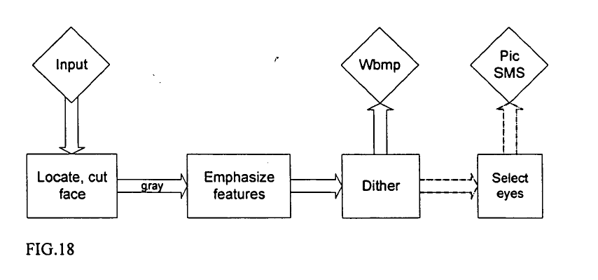

FIG. 18 shoes a block diagram explaining the procedure.

Envelope

Image is more or less frontal, eyes should be visible, and illumination variations should not be too extreme. Constraints are set both by face detection requirements and by binarization requirements. Size of face in image should be sufficiently big.

Compositions

a. Face detection, eyes detection:

Preferably, this would be a face detection SDK (e.g. trueFace, Facelt).

b. Illumination correction (to the extent possible).

c. Facial features emphasizing:

Increasing contrast—brightening the skin, darkening features (eyes, lips, eyebrows, etc.) and hair.

Sharpening.

d. Optimal resizing—undo the blur.

e. Binarization with dithering.

Faces to Picture Messages:

Output: The eyes strip.

Additional components: eye detection.

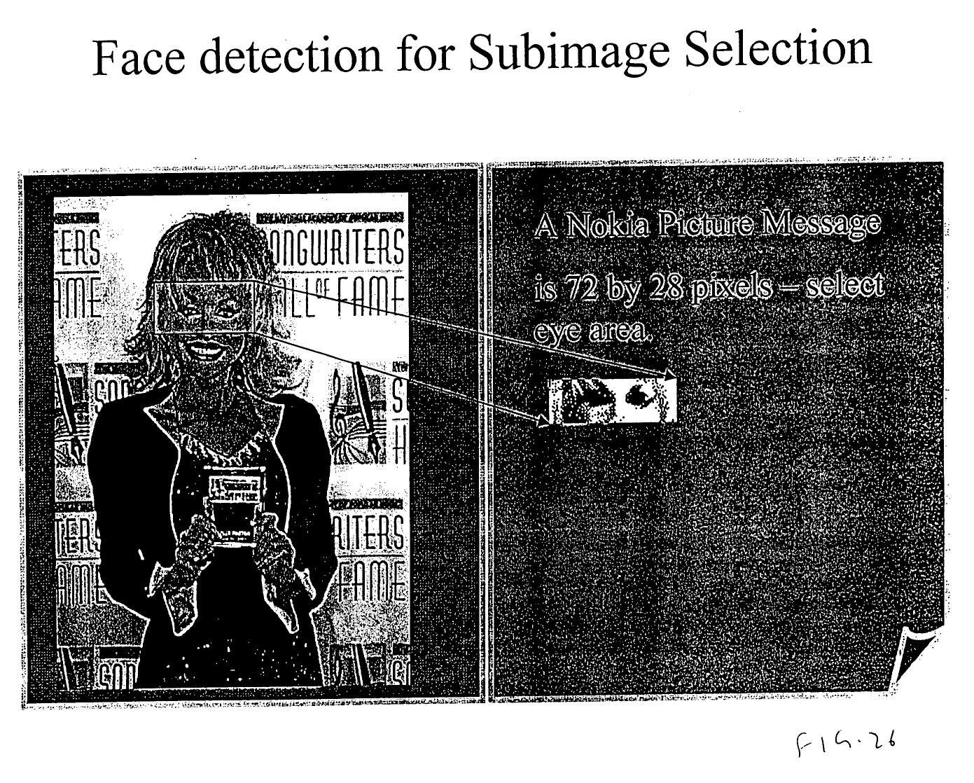

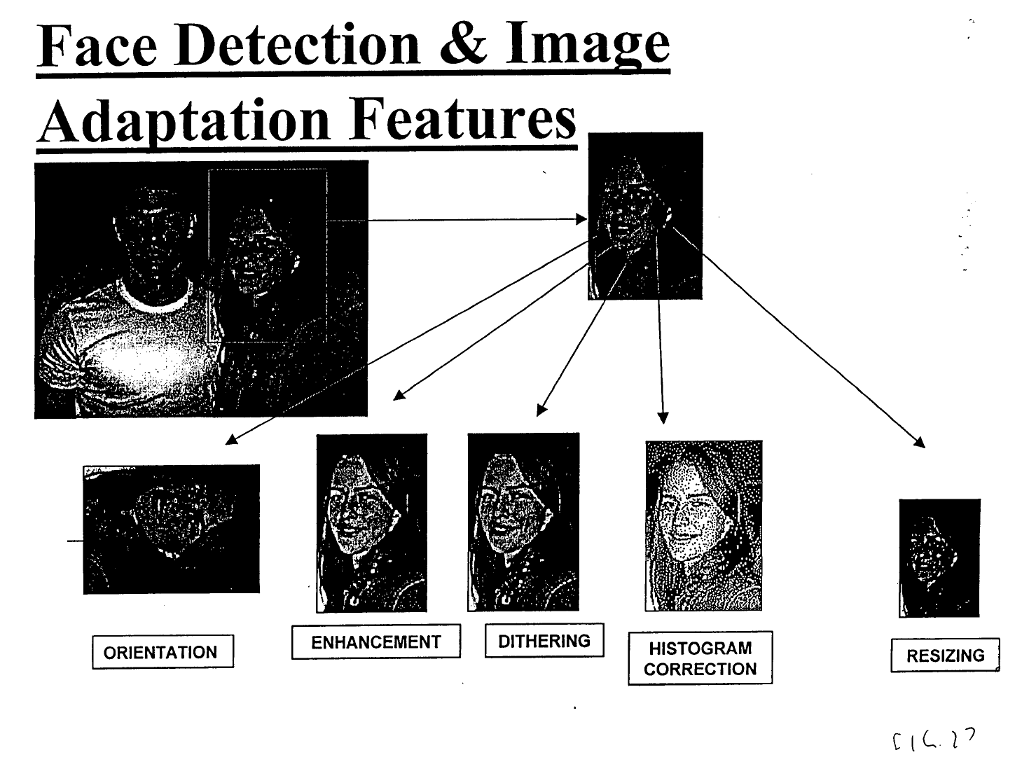

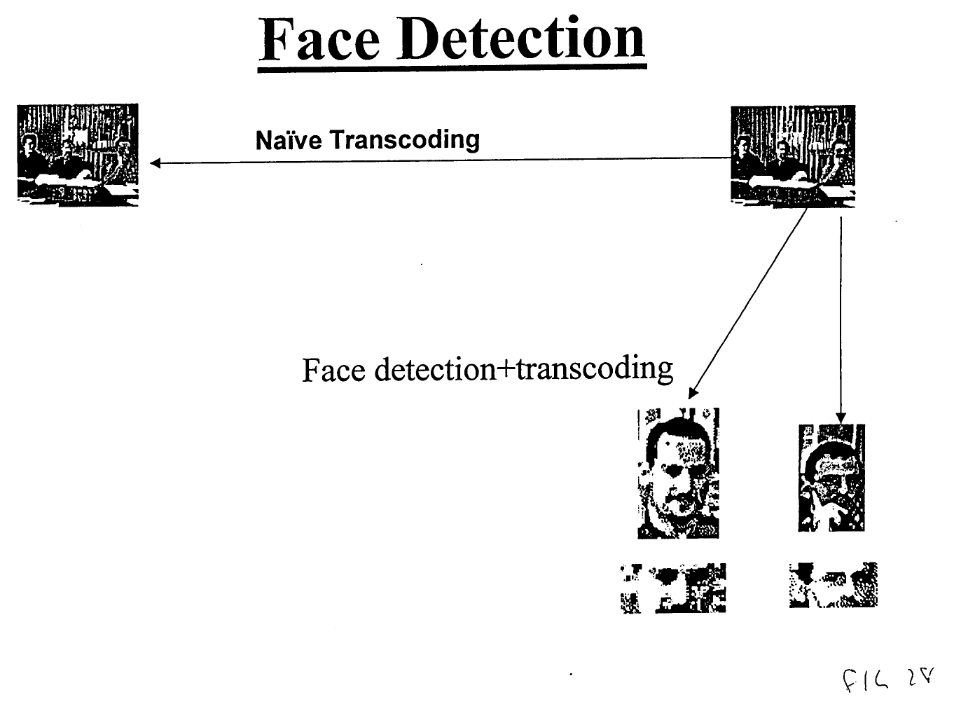

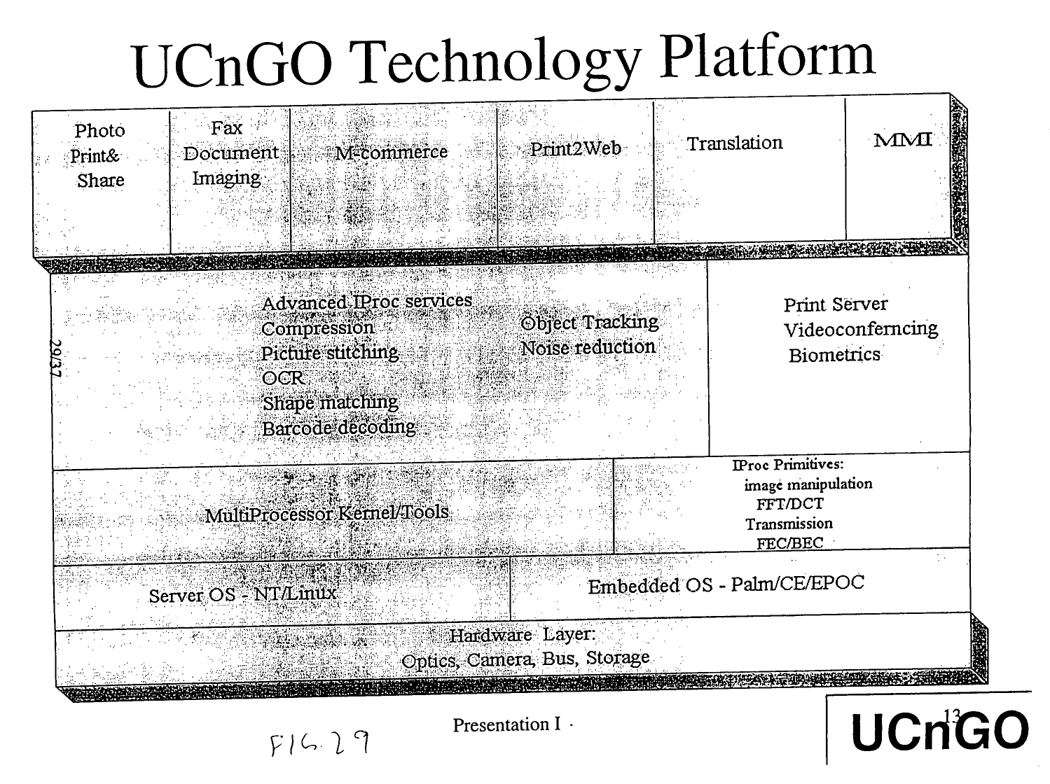

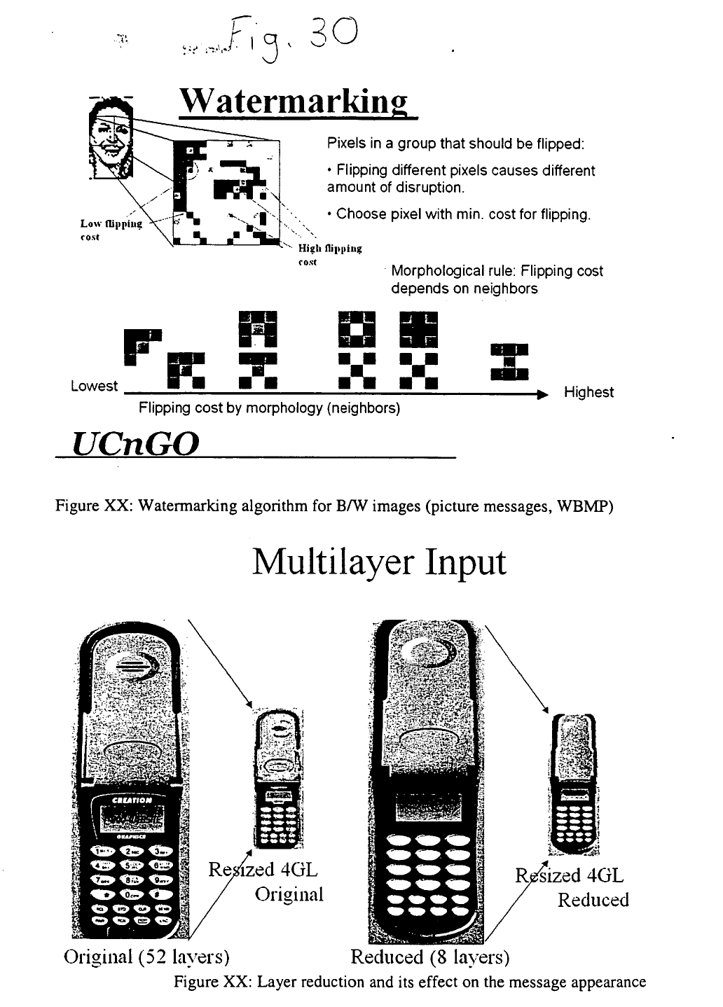

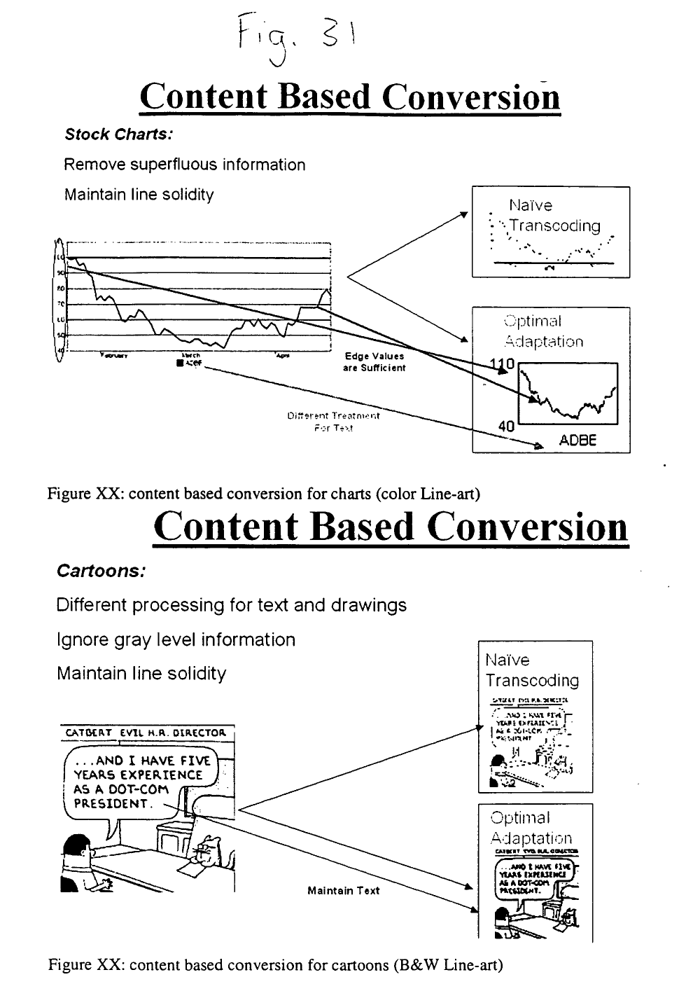

This is especially useful when one has to display a part of the human face on screens that dictate a wide and short frame size—e.g. many phones have an aspect ratio of 2:1 or more in the width/height of the display. In addition, the PM (picture message) format of Nokia Smart messaging dictates that images are at most 72 pixels wide by 28 pixels high. See examples in attached FIG. 26 showing the extraction of the eye region from an image and then converting it to a picture message.

Combination of Histogram Correction and Dithering

A histogram in the current context is the process by which the various pixel values in a grey level image are distributed on a frequency chart, from pure white through various shades of grey to pure black. Histogram correction is the process by which some of these values, but not all, are lightened or darkened, but even those values affected are changed to different degrees. Dithering is the translation of grey level images to black & white by the correct combination of the black and white pixels to simulate grey in the eye of the user. The use of dithering for small screens, such as those on the terminal displays discussed here, is entirely new. Histogram correction, even for small screens, is not new. However, the use of histogram correction in the method and system described herein is new. Further, there is a technique by which histogram correction is applied first, and then dithering, to transcode a very high quality image onto a terminal display that protrays only black & white images. This technique is entirely new, and is part of this invention.

Combination of Floyd Steinberg Dithering and Random Permutation

Floyd Steinberg dithering is a well-known dithering algorithm in which error diffusion methods are used to create visually appealing dithering with relatively few fixed repeating patterns. Random permutation is a technique by which a few random black pixels are changed to white and a few random white pixels are changed to black. Random permutation is used to avoid “periodidty”, which is a situation in which there are appear to be very dramatic changes in shading from one part of a picture to an adjacent part of the picture. This problem is particularly prevalent when large pictures are compressed into a smaller area such as a small display terminal. Random permutation softens the effect of these changes. Floyd Steinberg dithering is part of prior art, as is random permutation. However, the combination of first Floyd Steinberg dithering and then random permutation is new, and is part of this invention. Further, the addition of this combination followed by transcoding to WBMP, EMS, or PM, as the case may be the particular target terminal, is entirely new, and is part of this invention.

Correction for Non-Square Pixels in the Target Display

Not all terminals have square pixel displays; sometimes the pixels are rectangular. If that is the case, then the server may need to convert say a 100×100 square pixel picture into say 80×100 rectangular pixel display on the target terminal. The server will know the chacteristics of the display terminal, and will perform the required correction; that technique is new. Further, the addition of this technique with other techniques described here, and the transmission of the processed information, is entirely new, and is part of the method and system described herein.

Transcoding of Color and Shade in Images

Images generally in one of three types of color or shading, which are are color (green, blue, and red, or other permutations), grey level, and black & white. Terminal displays today are generally black & white only, although grey level is being introduced, color displays are planned for the future. The server will know the characteristics of the display terminal, and will be able to transcode source images into a display format suitable for that terminal. Note that it is possible to transcode down, or to transcode up from white & black to grey level, but it is not possible to transcode into color. That is, the various possible permutations are color to grey level, color to black & white, grey level to black & white, or black & white to grey level. However, grey level or black & white to color is not possible. Also, needless to say. It is possible to transcode at the same level, such as black & white to black & white, although different algorithms will be employed to to maximize integrity and quality of the image on the terminal display.

Panorama Imaging on a Terminal

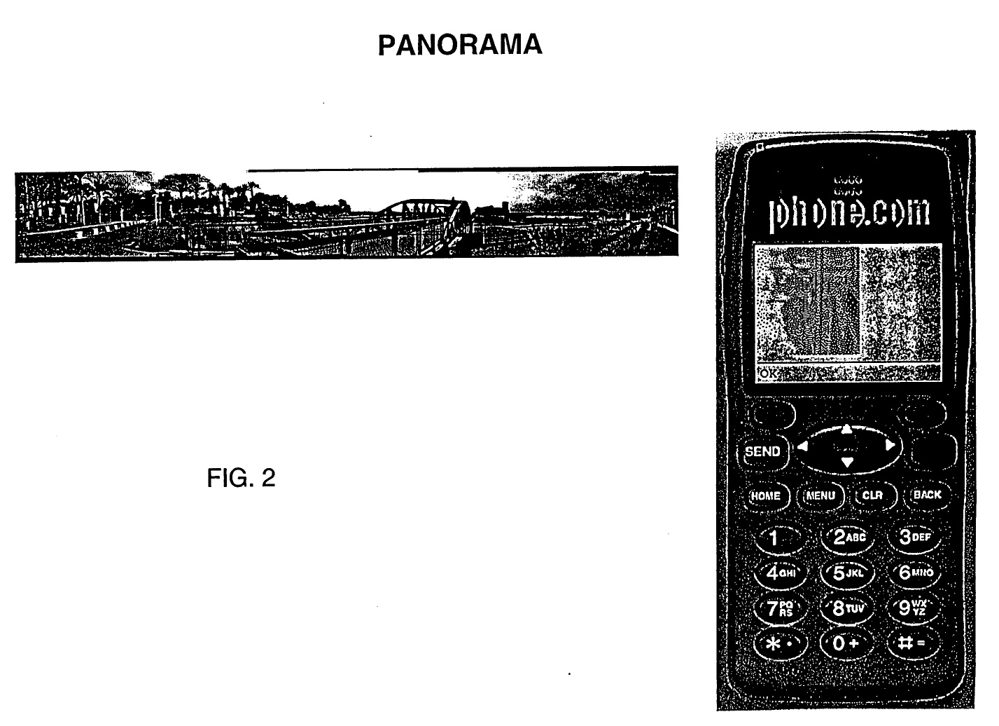

Refer to FIG. 2, attached to and incorporated into this application. Panorama imaging requires that multiple pictures of a scene be taken, and then various images be “stitched” together in order to create one continuous scene, [Note: Panorama imaging, and the various algorithms employed to make it possible, is the subject of a separate patent application by the current assignee, UCnGo, Inc.] By the nature of the limited size of the terminal display, the entire picture cannot be displayed on one screen. Scrolling is required. In addition, reorientation of the image may also be required, as demonstrated in FIG. 2. It should be noted that long text messages, which may not be displayed on one screen, may also be formatted for scrolling, and again the scrolling may be either vertical or horizontal, depending on the type of terminal display and the nature of the text.

Embedding a WAP Link in an SMS Message

This in itself is not new, since it is part of the prior art. However, it is new as part of the method and system described herein, particularly where the SMS link message serves as a method to deliver multimedia content to the user of a WAP phone.

OTA Bookmarks and Enrollment

“OTA” means “Over the Air”, and is a short expression for real time action, in this case via a radio system. To do personalized bookmarks and home pages OTA is part of the prior art. Each user is assigned a specific URL (“Uniform Resource Locator”), with a common beginning string and some additional user-specific string (e.g., http://wap.ucngo.com/mmsservice/userboxes/userid=4SFC9E0, where the bold part is user-specific part). In this way, different users receive different bookmarks (URLs), and when a user operates a specific WAP browser, the UCnGo server receives an HTTP request with a URL unique to the given user, and the server will know what information to display based on the specific URL. To give each user his or her own URL, is also part of the prior art, but only in a wireline environment. To give a URL to a wireless subscriber is new. To combine ULR with OTA for personalized bookmarks, personalized home pages, URL links, enrollment in various services, and other services, is new, and is part of this invention. This combination requires both the application of database technology and the algorithms defined in this application.

Correcting for inversion of Pixels on Target Display

In some terminals, the display has been intentionally inverted. That is, if a 0 bit is usually white, and a 1 bit usually black, in an inverted terminal the 0 bit appears as black and the 1 bit appears as white. Therefore, if any MMS message at all is sent, the display in an inverted terminal will show the message as a negative of the original, A Timeport phone, by Motorola, Inc., is an example of such an inverted display. This inversion is not a fundamental problem, as long as the server knows the terminal characteristics, and can correct for the inversion. The server in this application does know the terminal characteristics, and will correct for the inversion before the message is transmitted.

Transcoding of Text or Numerics into a Picture

The invention will transcode text or numbers into a picture. In WBMP, PM, or EMS format, as required by the target display. This is new.

Use of Modules Such as OCR and ICR to Identify and Process Text and Images

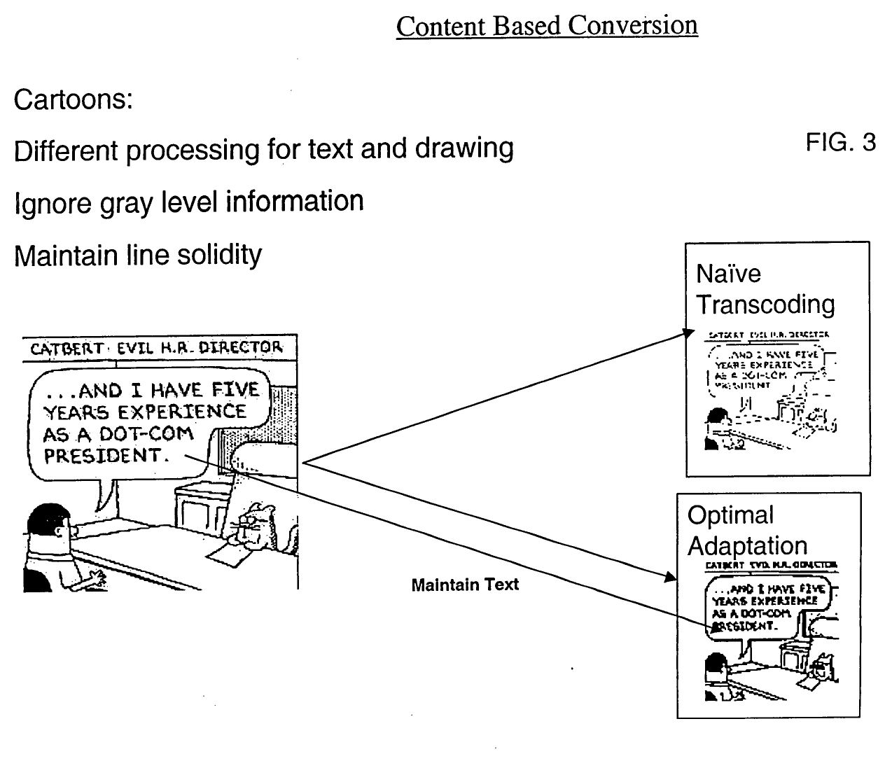

The server uses OCR and ICR (Intelligent Character Recognition) to identify which parts of an image are text. Reference is now made to FIG. 3, incorporated into this application. The first step in processing an image is the processing of the image into parcels such as text and drawing. Different processing techniques are then applied to each type of parcel. Rules will be applied, such as “Ignore grey level information” because the image may be in black & white, or “Maintain line solidity”. Without the parsing and application of techniques, the image will be reproduced on the terminal in a manner similar to what is written as “Naive Transcoding” on FIG. 3. With the invention, the “Optimal Adaptation” level is achieved. This process is part of the invention.

Flexibility Resizing

As a specific case, “flexible reswing” is a technique by which different parcels are resized differently; for example, text may be resized as little as possible to maintain legibility, whereas an image, such as that portrayed in FIG. 3, may have a greater degree of reduction, since only recognizability, not legibility, is required. Flexible resizing is also part of the invention.

Adaptive Classification Engine for Smart Resizing

A variation of flexible resizing is where the decision of flexible resizing is generated not solely by recognition algorithms, but rather by recognition algorithms in combination with parsed samples. The first step of the procedure is that various sample images are fed into the server's database. These images have already been parsed, and individual parcels have been identified as requiring different processing algorithms, in various orders of operation. The parsing, algorithms, and order of operation for the algorithms, have been tested by both theory and trial & error, and have found to produce optimal results. When a new image is then received by the server, the image can be parsed, the parsed parcels will then be compared to the database of parsed parcels, and the classification engine will then choose, on the basis of the samples and the target image, which algorithms and which combination of algorithms to apply to each parcel. This classification is “adaptive” In that in changes either with the addition of samples, and/or with feedback from the results of processing on real images. The adaptive classification engine is like a learning machine that applies rules and improves its own performance over time. The concept of a learning machine by itself is prior art. An adaptive classification engine for smart resizing of MMS messages is entirely new, and is part of this invention.

Vectorizing and Processing Charts and Cartoons

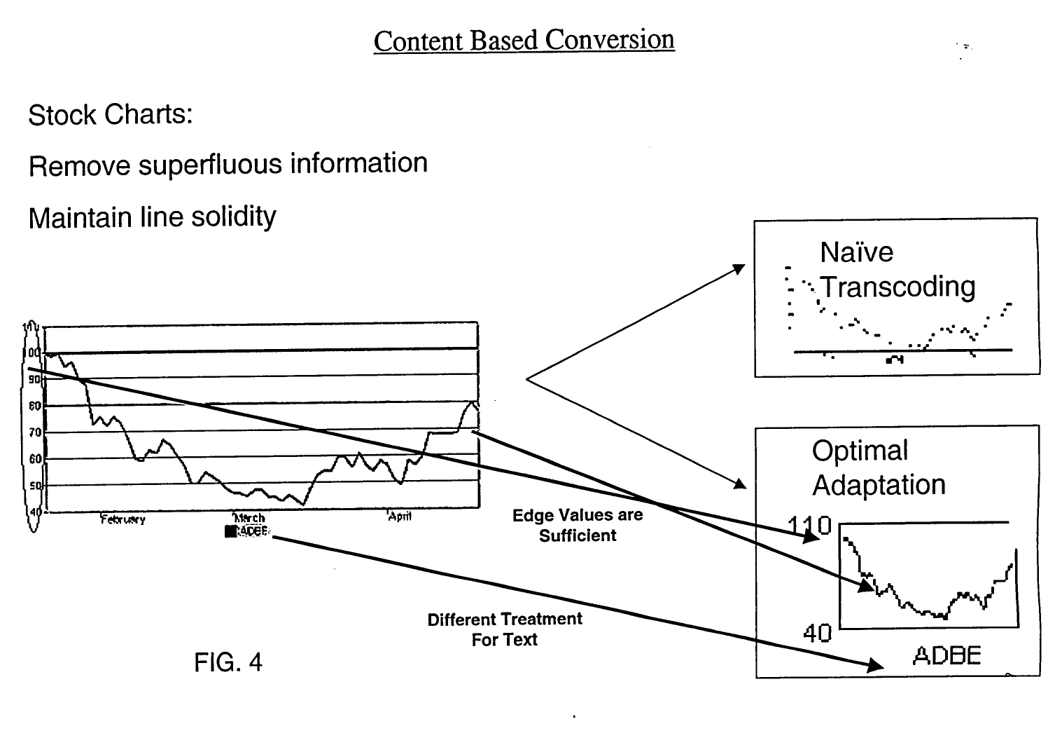

The processing of charts and cartoons is similar to the description of Use of Modules Such as OCR and ICR to identify and Process Text and images (see above). It is portrayed in FIG. 4, hereby incorporated into the application. That is, the image will be parsed to determine the various parcels to be processed. Then rules will be applied. For display of a standard size chart on the small display of a terminal, for example, superfluous information such as a series of values on the axes will be removed. Also, a rule such as “remove horizontals” may be applied, since the addition of the horizontals to the small display screen will make the graph almost unreadable. For the graph itself, a rule such as “maintain line solidity” may be applied. The entire image will then be resized to the small display. Vectorizing algorithms are prior art. For example, Adobe Streamline Software uses this technique. The technique has not been applied to small screens such as the terminals discussed herein, and that is new. The combination of that technique with resizing and the other operations described herein are part of the method and system of this invention.

This is a further explanation of the vectorizing and processing of charts:

Charts to WBMP

Envelope

Standard charts—graphs of a continuous one-dimensional function, e.g. stock charts and other temporal variables. (A better solution can be provided more easily for a known source with known format).

Components

a. Identification and separation of graphics to content layers: graph, grid and boundaries, graph label, range text (numbers on both scales), background. b. gnore clutter (background, grid, possibly grid boundaries).

c. Handle range: Ignore most values; maintain min, max at required size.

If possible, safely resize Use Ocr if needed/possible.

d. Handle graph label:

Long text: ignore, or ocr and return as text.

Short text (e.g. stock symbol/name): preserve label, but move it as needed.

Problem: range, label may not always be properly identified/handled for unknown format.

a. Resize graph:

Determine the maximal allowed size of the graph (after labels “waste”). With maximum scroll; with graph fully in screen, with graph and label fully in screen.

Determine which size to use.

Resize graph maintaining line continuity, and without thickening lines without necessity (consider graph as b/w).

Aspect ratio does not necessarily need to be maintained.

Block Diagram:

FIG. 18 shows a block diagram for the procedure.

Charts to Picture Message

Components—Changes from wbmp:

a. Grid boundaries ignored (or just marks); b. Handling range: Ignore horizontal range; c. Range and labels: Use Ocr if possible (return graph+“MSr, range 80-115”); d. Resizing graph is the same (with different parameters).

Conversion Algorithms s

Cartoon

Cartoon to WBMP

Envelope:

Content for the system is b/w line art. The size and amount of text should allow applying moderate resizing and fit, or recognizing through OCR. Typical samples are available at “K:\QA\Image_Banks\Comics\sliced comics\b&w”.

Components:

a. Correct conversion of generic content within the one-block envelope

b. Generic block identification and splitting

c. Handling text:
i. Identifying text.
ii. Identifying whether standard conversion would be ok.
iii. More moderate resizing+word reordering

Problems:

This may not always fit, Do we split it to multiple images?

Identifying optimal resizing.
iv. Specialized resizing to allow legibility after resizing.
v. Recognizing with Ocr:

Evaluate and tune use of both scansoft and ParaScript (cartoon text is closer to handprint)

Appropriate preprocessing.

Problems:

Cartoon text is small and not neatly printed—Ocr may fail.

Handling non-English text,
vi. Support getting text as input.

d. Recognizing and cleaning non-relevant text

Block Diagrams

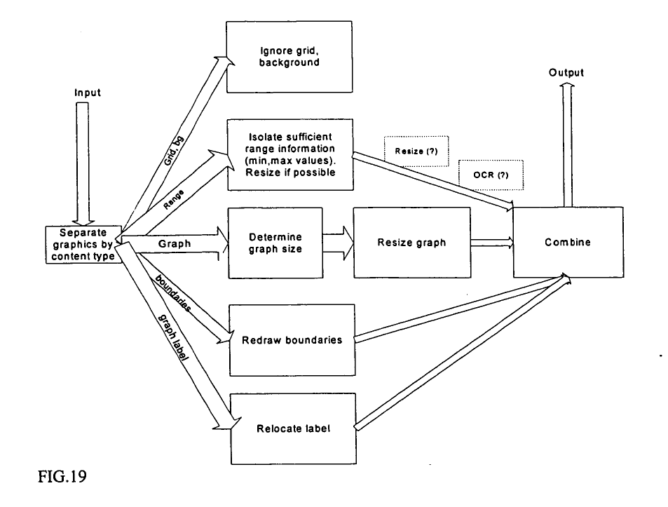

FIG. 19 shows a Block diagram without OCR.

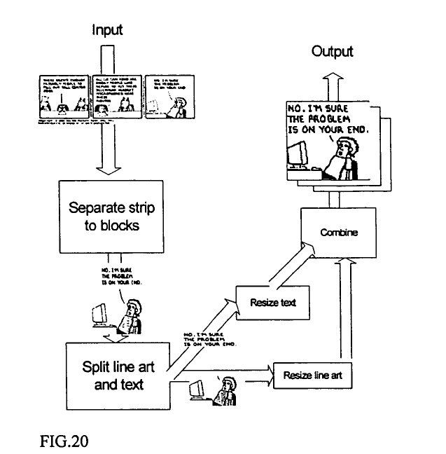

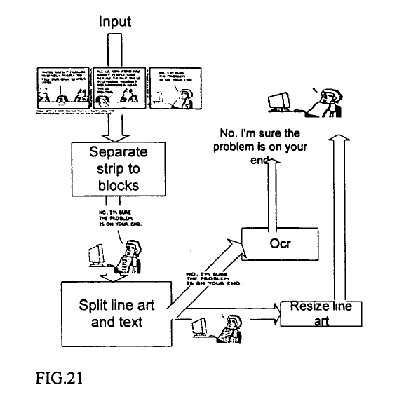

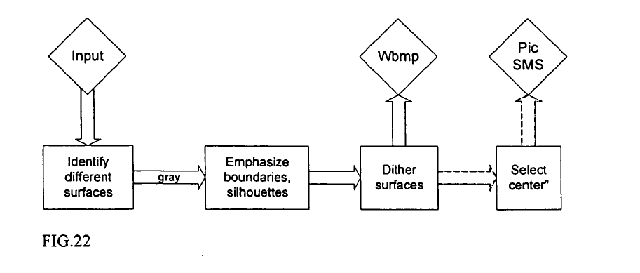

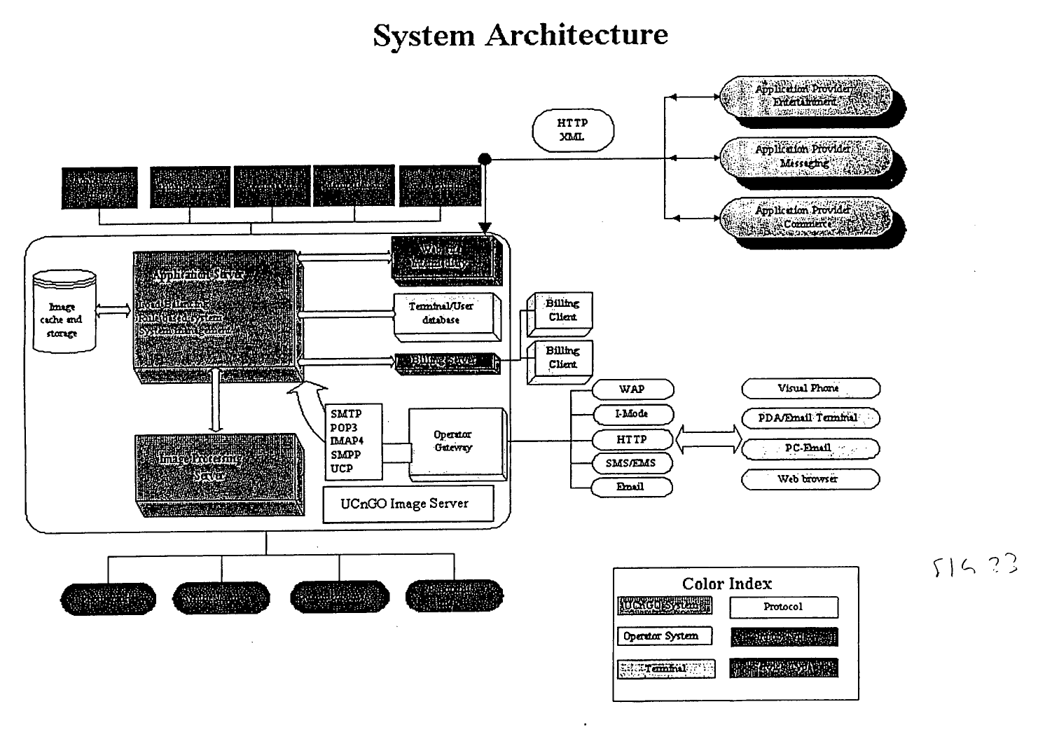

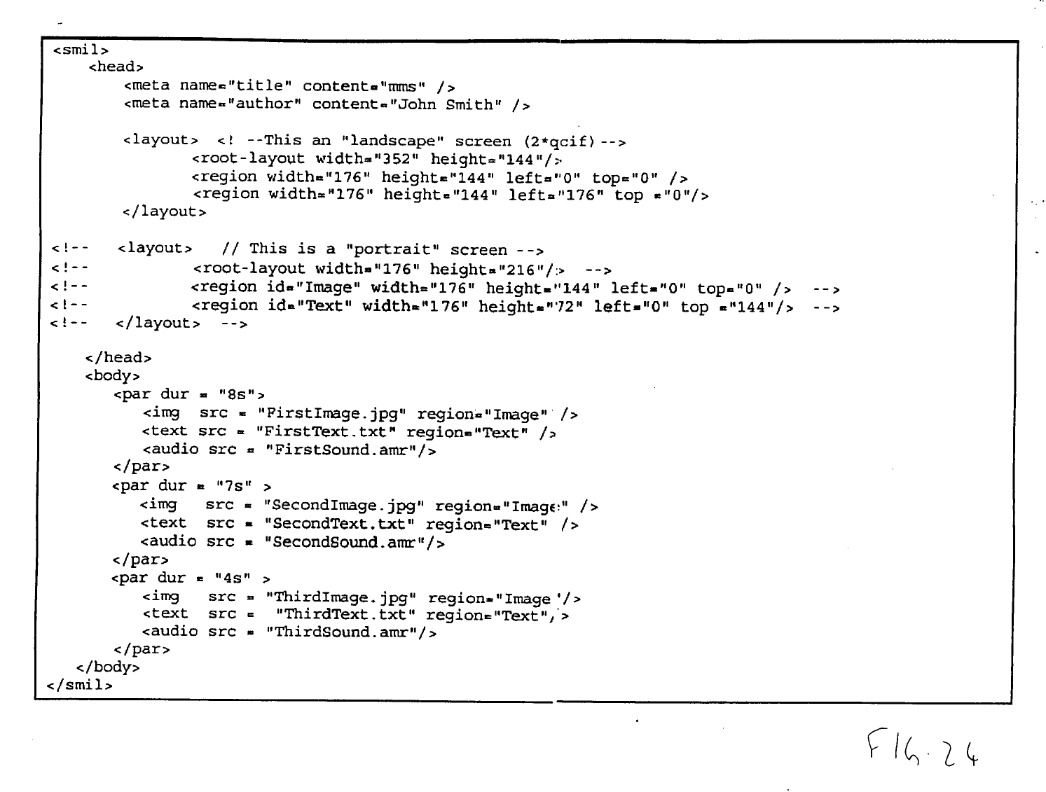

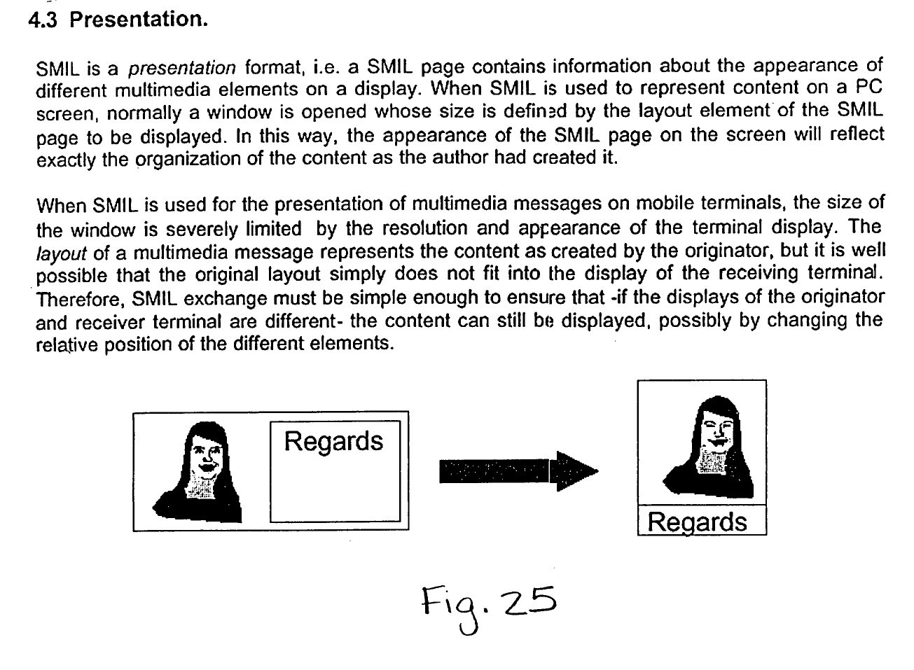

FIG. 20 shows a Block diagram with OCR:

Cartoon to Pictures SMS

All limitations and stages for wbmp apply.

Further envelope constraints.

Text must be Ocr-able or given as input.

Text limited to 60 characters.

Image part content must fit in 28 pixel (height).

An Example of a Combination of Techniques: Dithering, and then Adapting Photographs (with Different Image Material) to WMBP, EMS and/or PM, Format:

“Generic” Photo Binarization

Photo to WBMP

Typical scenes to be handled: car(s), profile of person, full body, multiple faces/people, skyline, signs, trees, etc.

Desired output is the silhouette of the object(s) in the image, an identifiable binarization of the scene.

FIG. 20 shows a Block diagram for this procedure.

Components:

a. Emphasizing boundaries, decreasing intra-surface changes (illumination, etc.).

b. Resizing

c. Identifying silhouettes.

d. Brightening background

e. Appropriate dithering within objects—when needed (only big surfaces).

f. Combining the silhouettes with the surfaces.

A data set for tuning and evaluation should be collected from current image banks+web.

Photos to Picture Message:

Problem: most scenes can't be converted to 28 pixels. It is usually difficult to identify important parts of the scene

Additional components:

“Central object” detection.

When that is not possible—additional resizing.

VAS Extended Functionality

It is expected that a large portion of MMS traffic will be generated by VAS application such as: photo albums, game sites, news sites etc. The UCnGO MCS provides special functionality for such services:

1. Watermark embedding/detection for digital rights management (DRM)—In order to track/block/limit the distribution of copyrighted content, a mechanism is provided to embed a watermark in any media object. This watermark does not change the image/sound of the media object in a perceptible way. It should be noted that this method does not interfere with other DRM mechanisms such as those provided already by Nokia (by special tags in WAP pages) and Ericsson (tags in content descriptor). It provides an additional mechanism which is independent of external tags.

2. Content Based Transcoding—the conversion of visual information (images, animations and video) to displays with limited color range, memory and resolution is enhanced by knowing the type of the visual content. For example, the optimal conversion algorithm of a chart into a B/W display is different from the optimal algorithm for a natural photograph. See FIG. 4 for examples.

3. Layered graphics input—the vast majority of professional graphic and photographic content is prepared using Adobe software tools such as PhotoShop. It is stored in a special format (PSD) which maintains the different layers of the image. Different layers can include the background, text images added from other sources etch it is not unusual for a high end image for the publishing or web-publishing industries to include over 50 separate layers. The MCS supports the PSD format as an input format, thereby preserving the original quality and enabling the content based detection module to handle each layer separately.

Message Interface

The MPS supports two distinct interfaces to the MMSC/external applications,

1. An XML-RPC/HTTP Interface, enabling platform and operating system decoupling between the MMSC and the MPS. This interface, documented in the attached ICD, enables complete control over the manipulation and conversion operations of the media objects and works at the media level.

2. A 3GPP standard, message-based interface designed in to make the integration of the UCnGO MPS as standard as possible for the OEM MMSC integrator or the VAS provider. The interface is based on the MM7/MM4/MM1 protocols. Using this interface, a complete unchanged MMS/Email message as received from the WAP GW/the other operator's MMSC/the VAS can be sent as is to the MCS, and the response from the MCS can be sent as is to the recipient phone/MMSC/VAS server.

Specifications:

The SMTP protocol (default port 25, configurable) or the HTTP POST protocol (configurable port) is used to transfer the message for processing. The message can be any standard MM1/MM4/MM7 message is defined in the 3GPP TS23.140 Release 5.20. document. The target device(s) type identification can be performed in the following manners.

The message header contains a set of (one or more) “X-MMS-UserAgent” or “X-MMS-UAprof” or “X-MMS-Model” descriptors—in this case these descriptors are taken as representing the model types for the different intended recipients as they appear in the message in the TO: data field.

The message header contains no extra information about the target devices, but an LDAP based user/device database has been configured to supply device parameters based on a user's MSISDN or email address. In this case the MCS performs an LDAP query for each target recipient specified in the “TO:” field of the message in order to find out the recipient terminal type.

The processed response in returned in one of the following manners:

The MCS can be configured to send the processed messages to a target SMTP server as MM7/MM4 messages. This way the MCS can sit between the external VAS/external MMSC and the local MMSC with no configuration changes.

The MCS can be configured to send the processed messages via HTTP POST to a target server as an MM1 message, This way the MCS can sit between the WAP GW and the MMSC MMS proxy.

The processed response(s) will be sent in MIME multipart format, with the presentation layer and media objects converted based on the recipient device. For example, for a WAP phone the presentation layer will be in the text-wml MIME types and images will be in GIF/WBMP format, The message will be submitted once per each target device, since the content for the different target devices is now different having undergone conversion. So for example an incoming MM7 message targeted at four recipients will generate four MM7 messages with one recipient each.

Presentation Level Conversion

Effective multimedia presentation requires some information on the spatial and temporal relations between the different media objects presented. This functionality is performed by the presentation layer—HTML in web pages and Email, WML in WAP pages, SMIL in MMS messages. Some multimedia formats (egg EMS) and phones (e g, Nokia 3510, Nokia 7210) do not support an explicit presentation language, but rather display the different media objects according to their own pre-defined logic.

This means that in addition to the media objects conversion, the presentation level description has to be converted. In more complex cases (e.g. when no presentation description language exists) the actual media conversion has to be changed to account for the presentation logic. Some examples are:

An image and accompanying text is to be sent to a WAP phone. By changing the image size target one can guarantee that the text will be able to be viewed on the screen together with the image without scrolling. This requires knowledge of the phone's effective (versus physical) display size, and control of the image size in pixels, the WML description (e.g. the align=‘left’ directive for the text), etc. Thus, the generated WML deck should contain the proper parameters.

An MMS message containing a cartoon with a set of images and associated text, alongside with SMIL description is sent to a Nokia 3510 which does not support SMILE Theme is no specific order for the media objects that is, the last image (the cartoon's ‘punchline’) can be the first image in the MMS message. Hence, if the SMIL description is just omitted, the received content will be worthless. The presentation level logic in this case has to order the media objects according to their desired display order as specified in the SMIL description, so that the Nokia user will get the cartoon in the proper sequence.

Specifications

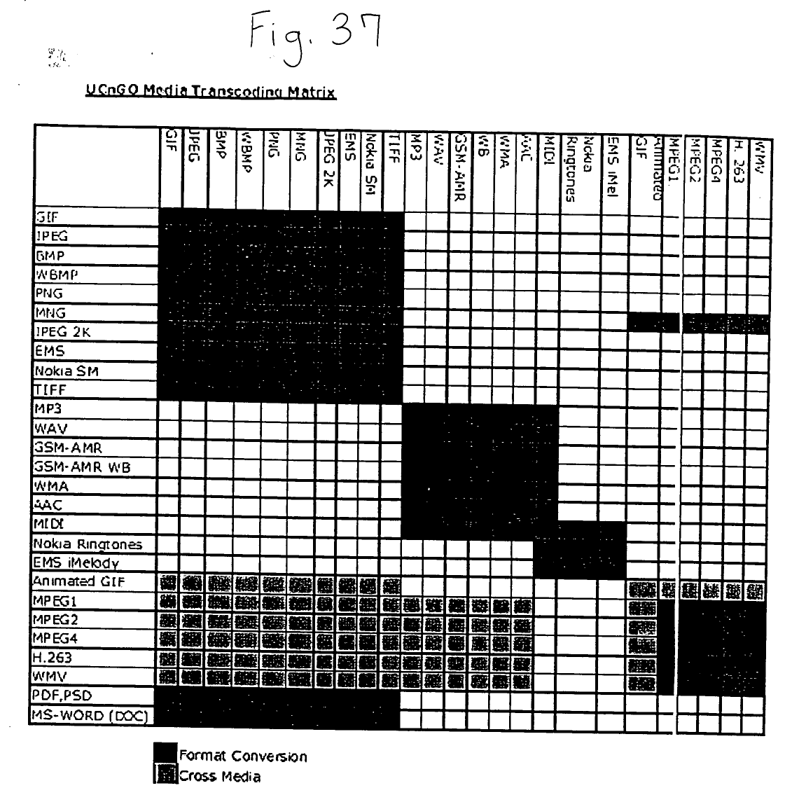

The UCnGO MCS provides for the presentation level conversion for the SMIL, MIME multipart, HTML, WML, EMS formats (see FIG. 37 for the supported conversion matrix). Of these, SMIL and MIME multipart are supported as input formats, and all are supported as output formats.

The supported conversion operations include:

Certain distribution circumstances in MMS lead to situation where the same content is sent to a large number of devices with similar or identical characteristics Examples are:

A VAS (e.g. a stock quote provider) sends an update to thousands of subscribers at the same time—in this situation hundreds of them will have identical phones and therefore media conversion should not be repeated for each one.

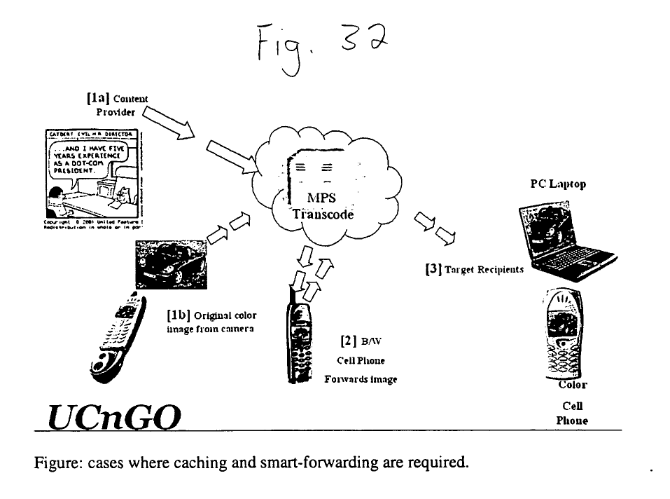

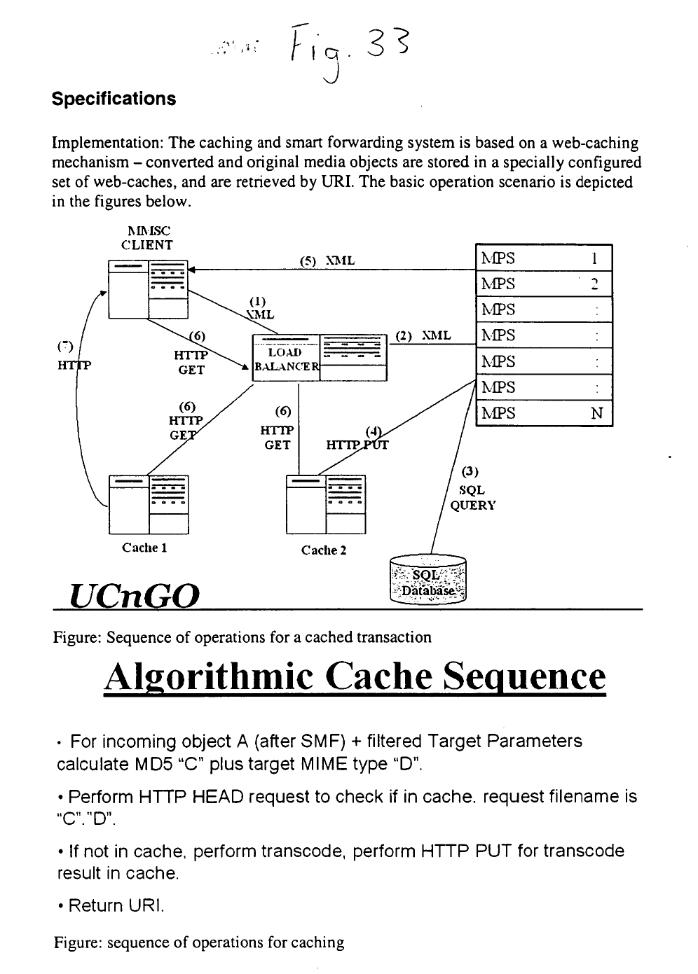

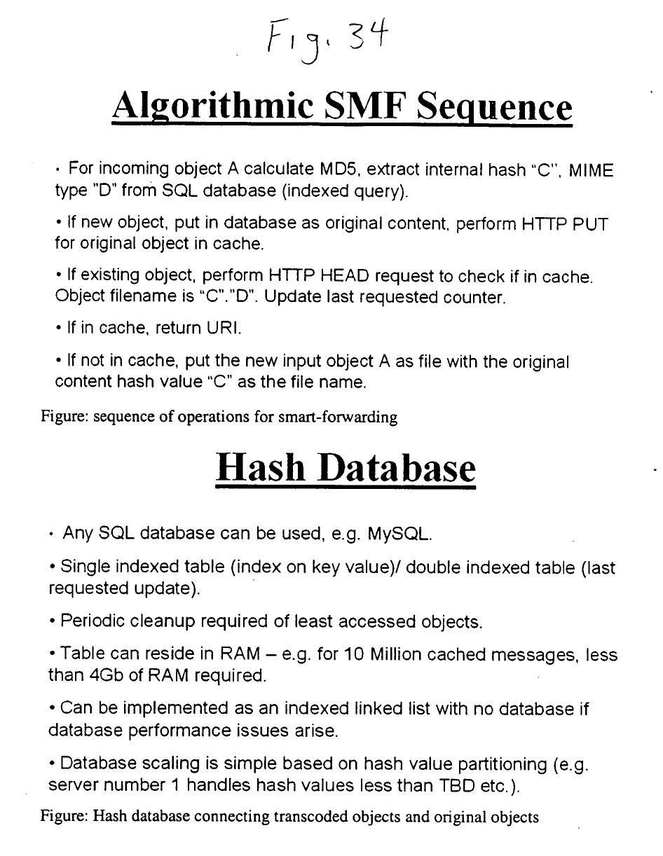

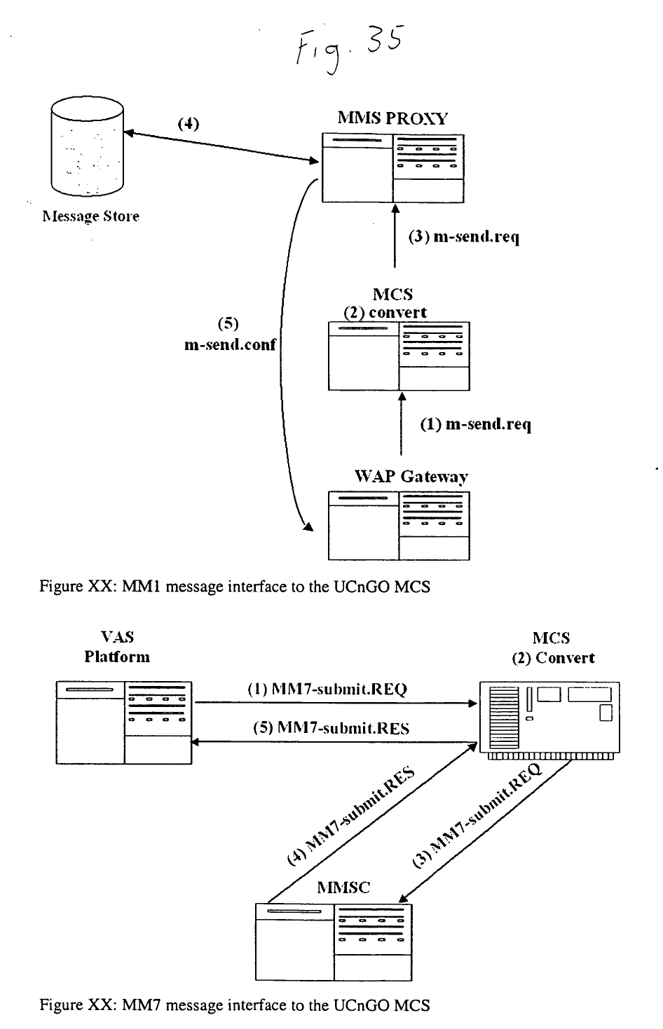

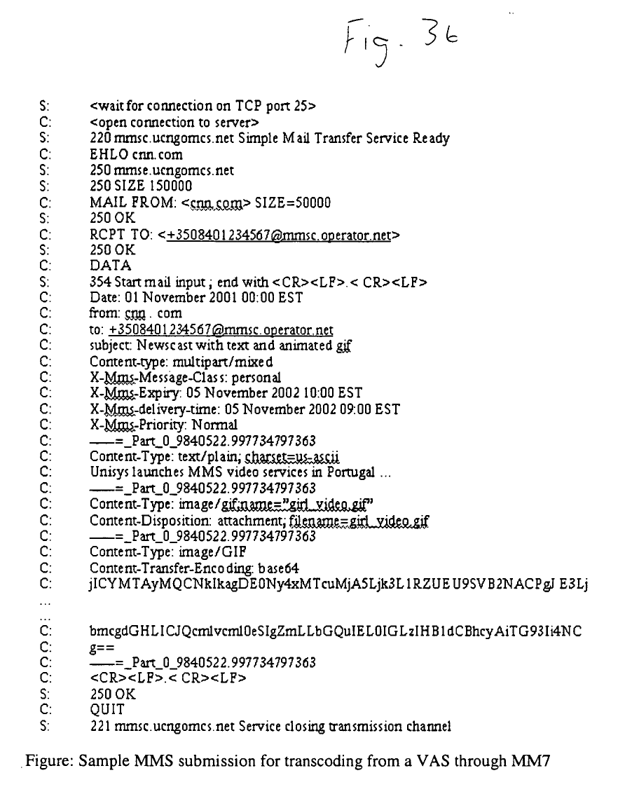

Superdistribution a user gets a funny message and forwards it to his buddies, who then send it onward to their friends etc. Since some of the recipients may use the same device, there is no need to keep converting the message again and again. Furthermore, the degradations caused by continuous conversion should and can be avoided. See for example FIG. 32—the 2nd recipient has a color enabled display, and hence should get a color image/video. This can only happen if smart forwarding is implemented.

In short, caching means that when a new transcoding/conversion request arrives, the MPS looks in the cache to see if an identical/practically identical request for transcoding of the same media object into an identical/practically identical device has been submitted in the past and if the result of this operation is still in the cache. If so, the URI of the object in the cache is returned as the transcoded result and the actual transcoding operation is avoided.

Smart forwarding is similar to regular caching, except that the MPS retrieves the cached transcoded result based on the original media object. That is, if a content request for object “B” (originally transcoded from object “A”) to device “T” is requested, the MPS retrieves the cached result of “A” transcoded into “T”, not of “B” transcoded into “T”.

Other modifications and variations to the invention will be apparent to those skilled in the art from the foregoing disclosure and teachings. Thus, while only certain embodiments of the invention have been specifically described herein, It will be apparent that numerous modifications may be made thereto without departing from the spirit and scope of the invention.

1. An MMS communication system for displaying images on a display terminal of a mobile or portable communication device, the system comprising:
an input adapted to receive pre-source information;
a transmitter adapted to transmit the pre-source information;
a server adapted to receive the transmitted pre-source information and further adapted to convert the pre-source information to source information suitable for display on the display terminal; and
a source transmitter adapted to transmit the source information to the display terminal.

2. The system of claim 1, wherein the server further comprises a display characteristics identifier adapted to identify display characteristics of the display terminal.

3. The system of claim 1, wherein the server further comprises a pre-source transcoder adapted to transcode pre-source information to source information.

4. The system of claim 1, wherein the served comprises at least one source transcoder adapted to transcode a first source information in a first format to a second source information in a second format,

5. The system of claim 4, wherein the second format corresponds to a display format for the display terminal.

6. A method for enabling communication of MMS information suitable for display on a mobile or portable communication terminal, comprising:
inputting pre-source information;
transcoding pre-source information into source information;
transcoding source information another source format suitable for display on the target display terminal;
transmitting the transcoded source information to the target display terminal;
displaying the transmitted and transcoded source information on the display space of a target display terminal in a format most suitable for that particular display terminal.
